(19) United States
(12) Patent Application Publication
(10) Pub. No.: US 2004/0119717 A1
(43) Pub. Date: Jun. 24, 2004

(54) Animation creating/editing apparatus

(75) Inventors: Yukihiko Furumoto, Kawasaki (JP); Naoyuki Nozaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/626,658

(22) Filed: Jul. 25, 2003

(30) Foreign Application Priority Data
Oct. 29, 2002 (JP) 2002-218621

(51) Int. Cl. G06T 15/70

(52) U.S. Cl. 345/473

(57) ABSTRACT

It is checked whether or not an operation instruction input is inconsistent with editing rules. If the operation instruction is inconsistent, it is determined as an error. It is checked for an object operation instruction whether or not it violates a constraint condition. If the object operation instruction violates the constraint condition, it is determined as an error. Interference checking is made for an object operation instruction which does not violate the constraint condition. If interference occurs, an object is moved to avoid the interference. If the interference cannot be avoided, the object operation instruction is determined as an error. If a scene must be complemented due to a move of an object or an eye point, this scene is complemented. Some of complemented operation instructions are recursively checked, and only an operation instruction which does not become an error is stored in an operation instruction storing unit.

### BACKGROUND OF THE INVENTION

1. Field of the Invention

The present invention relates to an apparatus and a program suitable for creating/editing an animation on which the real world is reflected.

2. Description of the Related Art

For example, if an event which has movements such as assembly of a device is explained, a plurality of illustrations are conventionally used. In recent years, however, moving images of an animation have been used.

An animation represents movements by switching a large quantity of continuous images at high speed. When an animation is created, editing operations such as linking of images once created, changing of an image order, etc. occur. With a conventional animation editing system, editing operations are performed by inserting/deleting/moving an image which configures an animation into/from/within the animation to be edited.

A conventional animation is only a set of a large quantity of images. For example, if an animation that explains the procedures for assembling a device is created, inconsistent scenes (for example, a scene on which a component is embedded into a certain portion succeeds a scene on which a cover in the portion is closed), or discontinuous scenes (for example, a scene on which a component is already attached to a device succeeds immediately after a scene on which the component is brought close to the device to be assembled) can be possibly created.

Unlike the world in which unreality such as a game, a cartoon, etc. is permitted, it is undesirable that the above described inconsistent or discontinuous scenes exist in an animation that explains an event in the real world, such as the procedures for assembling a device, etc.

However, a conventional animation editing system does not have a support capability for removing or resolving such inconsistent or discontinuous scenes if they are attempted to be created. Therefore, editing operations for replaying an animation once created, and for checking scenes like the above described ones while viewing the animation are required.

### SUMMARY OF THE INVENTION

An object of the present invention is to provide an animation creating/editing apparatus removing or resolving a scene that is inconsistent with the real world, discontinuous scenes that are unnatural, and the like when an animation on which the real world is faithfully reflected is created.

An animation creating/editing apparatus according to a first preferred embodiment of the present invention comprises a three-dimensional model storing unit, and an operation instruction editing unit.

The three-dimensional model storing unit stores an object which configures an animation image as three-dimensional model information. The operation instruction editing unit creates/edits an animation by generating/editing an operation instruction sequence configured by an object operation instruction and an eye point operation instruction, which are operation instructions for the object.

As described above, with the animation creating/editing apparatus according to the first preferred embodiment, an animation can be created/edited by using three-dimensional model information, and object and eye point operation instructions for the three-dimensional model information. Therefore, the amount of data for displaying an animation can be significantly reduced, and the animation can be created/edited quickly and efficiently.

An animation creating/editing apparatus according to a second preferred embodiment of the present invention further comprises an interference detecting unit, and an interference avoiding unit in addition to the units comprised by the animation creating/editing apparatus according to the first preferred embodiment.

The interference detecting unit detects an occurrence of interference between objects, which is caused by executing the object operation instruction. The interference avoiding unit generates an object operation instruction to avoid the interference, if the occurrence of the interference is detected by the interference detecting unit.

With the animation creating/editing apparatus according to the second preferred embodiment, creation of a scene on which objects interfere with each other is detected in advance, and a scene that can avoid the interference can be generated.

An animation creating/editing apparatus according to a third preferred embodiment of the present invention further comprises a discontinuity detecting unit, and a complementary instruction generating unit in addition to the units comprised by the animation creating/editing apparatus according to the first preferred embodiment.

The discontinuity detecting unit detects an occurrence of discontinuous scenes, which is caused by executing the eye point operation instruction or the object operation instruction. The complementary instruction generating unit generates an object or eye point operation instruction to generate a scene that complements the discontinuous scenes, if the occurrence of the discontinuous scenes is detected by the discontinuity detecting unit.

With the animation creating/editing apparatus according to the third preferred embodiment, an animation that generates discontinuous scenes can be prevented from being created, and a scene that resolves the discontinuity can be automatically generated.

In an animation creating/editing apparatus according to a fourth preferred embodiment of the present invention, the above described three-dimensional model information holds a constraint condition between objects. This apparatus further comprises a constraint detecting unit in addition to the units comprised by the animation creating/editing apparatus according to the first preferred embodiment.

The constraint detecting unit detects an object operation instruction which violates the constraint condition as an error.

With the animation creating/editing apparatus according to the fourth preferred embodiment, an object operation instruction which violates a constraint condition is detected as an error, so that an animation including a scene on which the real world is not reflected can be prevented from being created.

An animation creating/editing apparatus according to a fifth preferred embodiment of the present invention further comprises an editing rule storing unit, and an operation instruction editing unit in addition to the units comprised by the animation creating/editing apparatus according to the first preferred embodiment.

The editing rule storing unit stores editing rules to be observed when an object operation instruction is inserted/deleted/moved in/from/within the operation instruction sequence when an animation is edited. The operation instruction editing unit references the editing rules, and prevents/avoids an insertion/deletion/move operation in/from/within the instruction sequence, when the operation is performed for an object operation instruction which violates the editing rules.

With the animation creating/editing apparatus according to the fifth preferred embodiment, creation of an animation on which the real world is not properly reflected can be prevented/avoided by applying the editing rules.

### BRIEF DESCRIPTION OF THE DRAWINGS

FIG. 1 is a block diagram showing the configuration of an animation creating/editing system according to a preferred embodiment of the present invention;

FIG. 2 shows the data structure of three-dimensional model information stored in a three-dimensional model storing unit;

FIG. 3 shows a specific example of an object represented by three-dimensional model information;

FIG. 4 is a flowchart explaining the entire operations performed by the animation crediting/editing system according to the preferred embodiment;

FIG. 5 is a flowchart showing the details of a virtual space object move process in FIG. 4;

FIG. 6 is a flowchart showing the details of a complementary instruction generation process in FIG. 4;

FIG. 7 is a flowchart explaining an animation replay (display) process in the preferred embodiment;

FIG. 8 shows an original image displayed in the preferred embodiment;

FIG. 9 shows an image obtained by performing an eye point move operation for the original image shown in FIG. 8;

FIG. 10 shows an image obtained by performing a display attribute change operation for the original image shown in FIG. 8;

FIG. 11 shows an image obtained by performing an object rotation operation for the original image shown in FIG. 8;

FIG. 12 shows an image obtained by performing a constraint release operation for the original image shown in FIG. 8;

FIG. 13 shows an image obtained by performing an object move operation for the image shown in FIG. 12;

FIG. 14 explains a specific example (No. 1) of animation creation;

FIG. 15 explains the specific example (No. 2) of the animation creation;

FIG. 16 explains the specific example (No. 3) of the animation creation;

FIG. 17 explains the specific example (No. 4) of the animation creation;

FIG. 18 explains the specific example (No. 5) of the animation creation;

FIG. 19 explains the specific example (No. 6) of the animation creation;

FIG. 20 explains the specific example (No. 7) of the animation creation;

FIG. 21 explains the specific example (No. 8) of the animation creation;

FIG. 22 explains the specific example (No. 9) of the animation creation;

FIG. 23 explains the specific example (No. 10) of the animation creation;

FIG. 24 explains the specific example (No. 11) of the animation creation;

FIG. 25 explains the specific example (No. 12) of the animation creation;

FIG. 26 explains the specific example (No. 13) of the animation creation;

FIG. 27 explains the specific example (No. 14) of the animation creation;

FIG. 28 explains the specific example (No. 15) of the animation creation;

FIG. 29 explains the specific example (No. 16) of the animation creation;

FIG. 30 explains the specific example (No. 17) of the animation creation;

FIG. 31 explains the specific example (No. 18) of the animation creation;

FIG. 32 explains the specific example (No. 19) of the animation creation;

FIG. 33 explains the specific example (No. 20) of the animation creation;

FIG. 34 explains the specific example (No. 21) of the animation creation;

FIG. 35 explains the specific example (No. 22) of the animation creation;

FIG. 36 shows the contents of an operation instruction sequence generated by the animation creation operations in FIGS. 15 to 35;

FIG. 37 explains an example (No. 1) where an error is caused by an object move instruction;

FIG. 38 explains the example (No. 2) where the error is caused by the object move instruction;

FIG. 39 explains an example (No. 1) where an error is caused by an attribute change instruction in a movable range;

FIG. 40 explains the example (No. 2) where the error is caused by the attribute change instruction in a movable range;

FIG. 41 explains an example (No. 1) where interference can be avoided;

FIG. 42 explains the example (No. 2) where the interference can be avoided;

FIG. 43 explains the example (No. 3) where the interference can be avoided;

FIG. 44 explains the example (No. 4) where the interference can be avoided;

FIG. 45 explains the example (No. 5) where the interference can be avoided;

FIG. 46 explains the example (No. 6) where the interference can be avoided;

FIG. 47 explains the example (No. 7) where the interference can be avoided;

FIG. 48 exemplifies an editing screen for the operation instruction sequence shown in FIG. 36;

FIG. 49 explains an animation editing operation performed by the animation editing system according to the preferred embodiment (No. 1);

FIG. 50 explains an animation editing operation performed by the animation editing system according to the preferred embodiment (No. 2);

FIG. 51 explains an animation editing operation performed by the animation editing system according to the preferred embodiment (No. 3);

FIG. 52 explains an animation editing operation performed by the animation editing system according to the preferred embodiment (No. 4);

FIG. 53 explains an animation editing operation performed by the animation editing system according to the preferred embodiment (No. 5);

FIG. 54 explains an animation editing operation performed by the animation editing system according to the preferred embodiment (No. 6);

FIG. 55 explains an animation editing operation performed by the animation editing system according to the preferred embodiment (No. 7);

FIG. 56 explains an animation editing operation performed by the animation editing system according to the preferred embodiment (No. 8);

FIG. 57 explains an animation editing operation performed by the animation editing system according to the preferred embodiment (No. 9);

FIG. 58 explains an animation editing operation performed by the animation editing system according to the preferred embodiment (No. 10);

FIG. 59 explains an animation editing operation performed by the animation editing system according to the preferred embodiment (No. 11);

FIG. 60 explains an animation editing operation performed by the animation editing system according to the preferred embodiment (No. 12);

FIG. 61 explains an animation editing operation performed by the animation editing system according to the preferred embodiment (No. 13);

FIG. 62 explains an animation editing operation performed by the animation editing system according to the preferred embodiment (No. 14);

FIG. 63 shows an operation instruction sequence generated when the image shown in FIG. 51 is edited;

FIG. 64 shows an operation instruction sequence generated when the image shown in FIG. 52 is edited;

FIG. 65 shows an operation instruction sequence generated when the image shown in FIG. 55 is edited;

FIG. 66 shows an operation instruction sequence generated when the image shown in FIG. 58 is edited;

FIG. 67 shows an operation instruction sequence generated when the image shown in FIG. 60 is edited;

FIG. 68 shows an operation instruction sequence generated when the image shown in FIG. 61 is edited;

FIG. 69 explains an operation for displaying the image shown in FIG. 62 from that shown in FIG. 61; and

FIG. 70 shows a dialog box for operating an object to be operated.

### DESCRIPTION OF THE PREFERRED EMBODIMENTS

A preferred Embodiment according to the present invention is described with reference to the drawings.

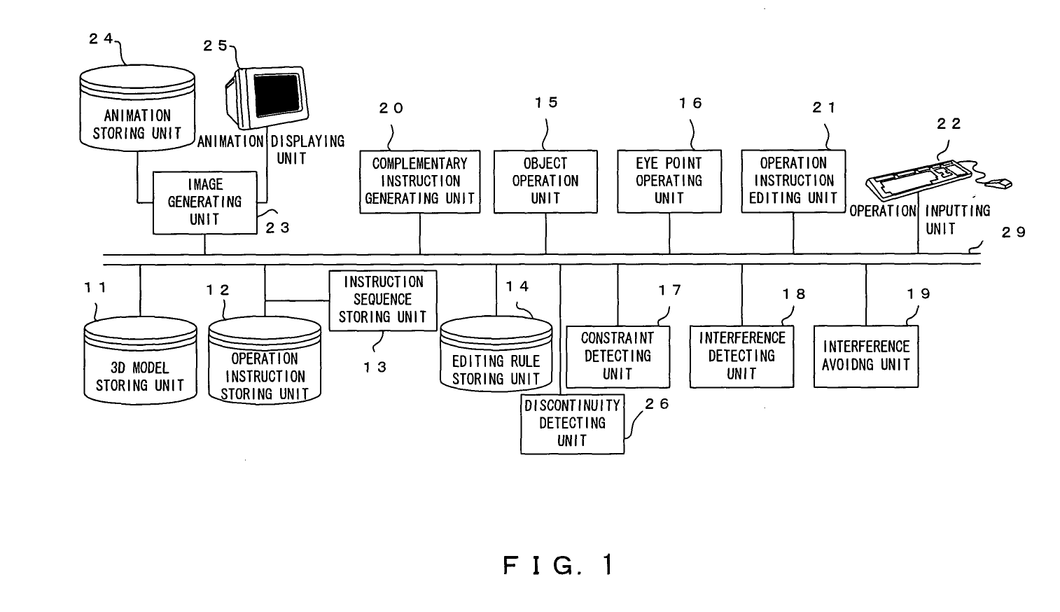

FIG. 1 is a block diagram showing the configuration of an animation creating/editing apparatus according to a preferred embodiment.

The animation creating/editing system (animation creating/editing apparatus) 10 shown in this figure is configured by a three-dimensional model storing unit (3D model storing unit) 11, an operation instruction storing unit 12, an instruction sequence selecting unit 13, an editing rule storing unit 14, an object operating unit 15, an eye point operating unit 16, a constraint detecting unit 17, an interference detecting unit 18, an interference avoiding unit 19, a discontinuity detecting unit 26, a complementary instruction generating unit 20, an operation instruction editing unit 21, an operation inputting unit 22, an image creating unit 23, an animation storing unit, and an animation displaying unit 25. The constituent elements 11, 12, and 14 to 23 among the constituent elements 11 to 25 are interconnected by a bus 29.

The three-dimensional model storing unit 11 stores three-dimensional model information that defines the shape/the configuration of an object (a person, a physical object etc. that appears in an animation), which configures an image of an animation. The three-dimensional model storing unit 11 holds a constraint condition between objects (a relationship where one object is constrained by another object and cannot move alone, a restriction on the move direction or the movable range of an object, and the like). In this preferred embodiment, the move of an object can be made only within a range according to this constraint condition. An object move instruction which does not observe the constraint condition is detected as an error by the constraint detecting unit 17.

The operation instruction storing unit 12 stores a plurality of series of operation instructions (instruction sequences) for an eye point or an object. The instruction sequence selecting unit 13 selects one instruction sequence from among the plurality of instruction sequences stored in the operation instruction storing unit 12.

The editing rule storing unit 14 stores rules when an animation is edited. Examples of the rules include the following.

(1) A target object must be in a disassembled state if an object move instruction is inserted in an instruction sequence.

(2) A target object must be moved without changing the order of an object move/rotation instruction and a constraint change (disassembly/assembly) instruction, if the object move/rotation instruction is moved within an instruction sequence.

(3) A movable direction must be set if an instruction to change the movable range of an object is inserted in an instruction sequence.

(4) A movable range change instruction to move beyond the movable range of a target object should not exist if the instruction to change the movable range of an object is inserted in an instruction sequence.

The object operating unit 15 operates an object in virtual space upon receipt of an input of an object operation instruction from a user. At this time, the interference detecting unit 18 checks the interference between objects, which accompanies the operation. If the interference occurs, the interference avoiding unit 19 modifies the move direction of an object to a direction where the interference is resolved, so that the interference is avoided. If the interference cannot be avoided, the object operation instruction becomes an error. Or, if an object can be moved without causing interference, the object operation instruction is stored in a corresponding instruction sequence within the operation instruction storing unit 12 via the instruction sequence selecting unit 13. The object operating unit 15 also performs a constraint deletion operation for an object. This constraint deletion operation is implemented by an operation for removing an object from a tree to which the object belongs. As a result, the object is released from the constraint of, for example, a parent object.

The eye point operating unit 16 moves an eye point in virtual space upon receipt of an input of an eye point operation instruction from a user. The move of the eye point in the virtual space can be made freely. If the user performs an eye point operation, its contents are stored in a corresponding instruction sequence within the operation instruction storing unit 12 via the instruction sequence selecting unit 13.

The constraint detecting unit 17 references a constraint condition stored in the three-dimensional model storing unit 11, and detects an object operation instruction which violates the constraint condition as an error, as described above.

The interference detecting unit 18 checks whether or not interference occurs between objects, when the object operating unit 15 operates an object in virtual space, as described above.

The interference avoiding unit 19 changes an operation for an object to a direction where interference is avoided, if the interference detecting unit 18 determines that the interference occurs between objects due to an object operation.

The discontinuity detecting unit 26 detects an occurrence of discontinuous scenes, when an eye point operation instruction or an object operation instruction is executed.

The complementary instruction generating unit 20 generates an operation instruction to generate a scene (image) that complements discontinuity when the discontinuity detecting unit 26 detects an occurrence of discontinuous scenes. The complementary instruction generating unit 20 generates the operation instruction based on the eye point of scenes the position of an object before and after a discontinuous scene.

The operation instruction editing unit 21 creates or edits an animation. An animation is created by generating an operation instruction sequence (instruction sequence), which is a series of operation instructions, while sequentially generating an object operation instruction and an eye point operation instruction for objects (parent and child objects, etc.) stored in the three-dimensional model information 40, and by storing the generated operation instruction sequence in the operation instruction storing unit 12 via the instruction sequence selecting unit 13. Additionally, an animation is edited by inserting/deleting/moving an object operation instruction or an eye point operation instruction in/from/within an instruction sequence (a series of operation instructions) stored in the operation instruction storing unit 12. The operation instruction editing unit 21 references the editing rules stored in the editing rule storing unit 14 when an animation is edited. If an editing operation inconsistent with the editing rules is determined to be performed, the operation instruction editing unit 21 converts the operation instruction which causes the inconsistency into an operation instruction to avoid the inconsistency, or determines the editing operation as an error. For example, if an instruction to move an object is attempted to be moved at the timing before the constraint of the object is released, the inconsistency is avoided by moving also an instruction to release the constraint of the object.

The operation inputting unit 22 is a device with which a user inputs an eye point or object operation instruction. This unit comprises, for example, a keyboard, a pointing device such as a mouse, etc.

Examples of eye point operation instructions include eye point move/rotation, zoom-in, pan-out, etc. Additionally, examples of object operation instructions include object move/rotation, a configuration change, an attribute (movable direction movable range, display attribute, operation prohibition attribute, etc.) change, etc.

Formats of these instructions are, for example, as follows.

(1) Eye Point Move

MoveCamera azimuth angle zenith angle view radius sight point

(2) Object Move

Move object ID x increment y increment z increment

(3) Object Rotation

Rotate object ID axis angle

(4) Configuration Change

Joint object ID parent object ID movable direction movable range

The image creating unit (image generating unit) 23 creates an animation image from the three-dimensional model information stored in the three-dimensional model storing unit 11, and the instruction sequence that is selected by the instruction sequence selecting unit 13 and stored in the operation instruction storing unit 12. The image creating unit 23 makes the animation displaying unit 25 display the created animation image, or stores the animation image in the animation storing unit 24.

The animation storing unit 24 is a storage device storing an animation image created by the image creating unit 23, and is a hard disk, a DVD-RAM, etc.

The animation displaying unit 25 is a display device replaying the animation image created by the image creating unit 23, and is a CRT display, a liquid crystal display, a plasma display, etc.

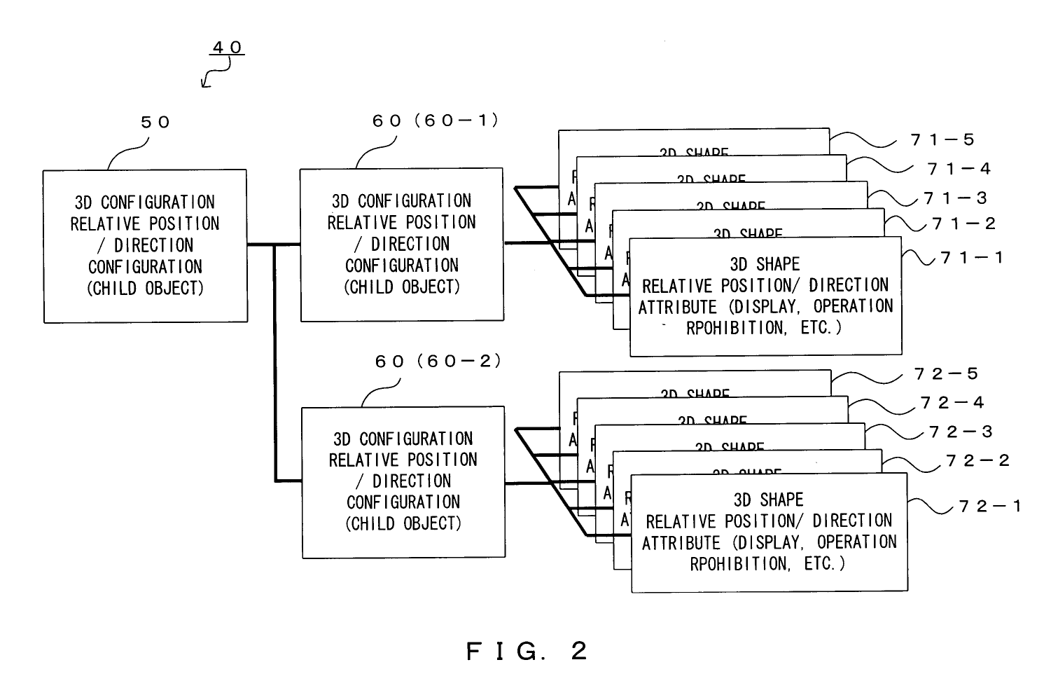

FIG. 2 exemplifies the data structure of three-dimensional model information stored in the three-dimensional model storing unit 11.

As shown in this figure, the three-dimensional model information 40 which represents an object (for example, one device) has a tree structure. The three-dimensional model information 40 is configured by three-dimensional configuration information (3D configuration information) 50 in the highest hierarchy (root), three-dimensional configuration information (3D configuration information) 60-1 and 60-2 in the second hierarchy, and three-dimensional shape information (3D shape information) 71 (71-1, 71-2, 71-3, 71-4, 71-5, . . . ) and 72 (72-1, 72-2, 72-3, 72-4, 72-5, . . . ) in the third hierarchy.

The three-dimensional configuration information 50 has two pieces of three-dimensional configuration information 60 (60-1 and 60-2) as child objects (for example, device units). The three-dimensional configuration information 60-1 has a plurality of pieces of three-dimensional shape information 71 (71-1, 71-2, 71-3, 71-4, 71-5, . . . ) as child objects. In the mean time, the three-dimensional configuration information 60-2 has a plurality of pieces of three-dimensional shape information 72 (72-1, 72-2, 72-3, 72-4, 72-5, . . . ) as child objects (for example, components configuring a unit).

The three-dimensional configuration information 50 has the following items of information.

relative position/direction

configuration (child object)

movable direction/range

Also the three-dimensional configuration information 60 (60-1 and 60-2), which are the child objects of the three-dimensional configuration information 50, have a configuration similar to the three-dimensional configuration information 50, and has the following items of information.

relative position/direction

configuration (child object)

movable direction/range

The three-dimensional shape information 70 (71 and 72), which are the child objects of the three-dimensional configuration information 60, have the following items of information.

relative position/direction

attribute (display, operation prohibition, etc.)

Here, a change in the relative position/direction in a higher hierarchy is reflected on the relative position/direction in a lower hierarchy. Additionally, the interference checking between objects by the above described interference detecting unit 18 is made based on the relative position/direction information of the three-dimensional configuration information 50, the three-dimensional configuration information 60, and the three-dimensional shape information 71 and 72. The three-dimensional model information 40 shown in FIG. 2 is merely one example, and may be a configuration composed of more hierarchies.

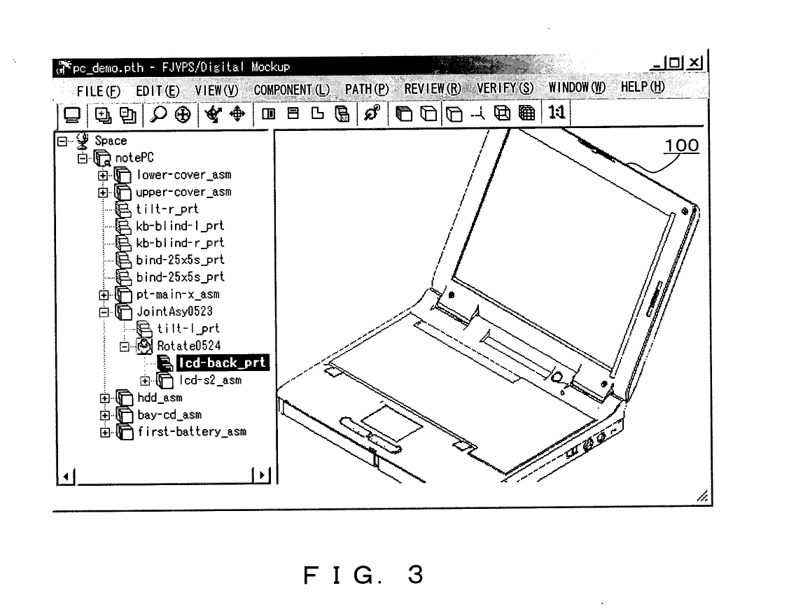

FIG. 3 exemplifies an object represented by the three-dimensional model information 40 shown in FIG. 2.

The whole of a notebook personal computer (notebook PC) 100 shown in FIG. 3 is represented by the three-dimensional configuration information 50, and each of units is represented by the three-dimensional configuration information 60. Additionally, each of components (keyboard, CD, HDD, battery, etc.) of each of the units is represented by the three-dimensional shape information 70.

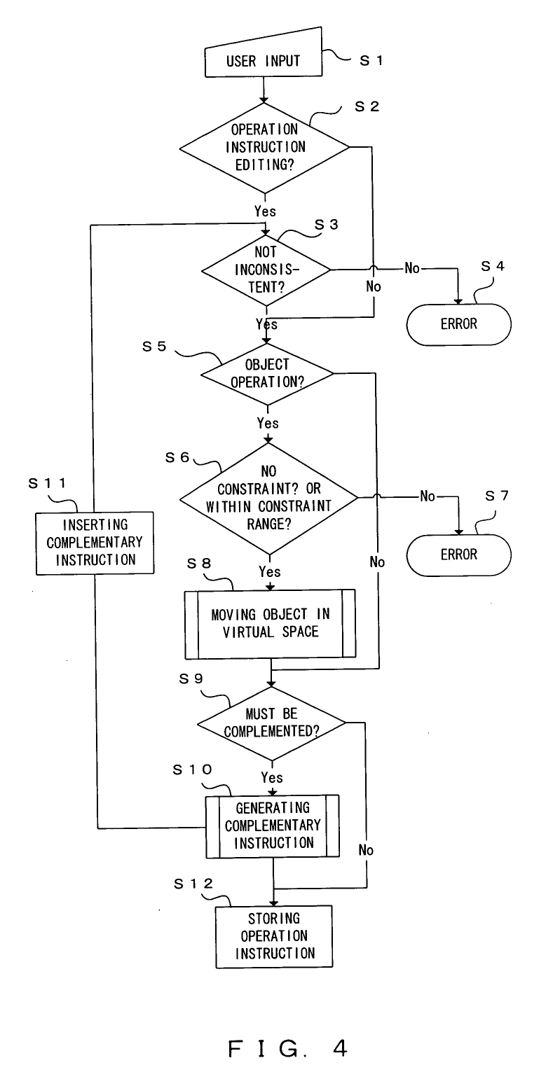

FIG. 4 is a flowchart explaining the editing operations performed by the animation editing system 10 having the above described configuration. Assume that an instruction sequence (stored in the operation instruction storing unit 12), which corresponds to an animation to be edited, is selected by a user prior to the start of the process represented by this flowchart.

When the user first makes an input via the operation inputting unit 22 (step S1), it is determined whether or not this input is operation instruction editing (insertion/deletion/move of an operation instruction in/from/within the instruction sequence) (step S2).

If the input is the operation instruction editing, the operation instruction editing unit 21 references editing rules stored in the editing rule storing unit 14, and determines whether or not the operation instructed by the user is inconsistent with the editing rules (step S3). If the operation instruction is inconsistent, the operation instruction is determined as an error (step S4).

If the operation instruction is not inconsistent in step S3, it is further determined whether or not the user input is an object operation instruction (step S5). If the user input is the object operation instruction, the constraint detecting unit 17 references the three-dimensional model storing unit 11, and determines (1) whether or not the move of a target object, which is made by the object operation instruction, violates a constraint condition if the target object of the object operation instruction holds the constraint condition, or (2) whether or not the move of a target object, which is made by the object operation instruction, is within a constraint range (movable range) if the target object of the object operation instruction does not hold a constraint condition (step S6). If the object operation instruction violates the above described condition (1) or (2), the constraint detecting unit 17 determines the object operation instruction as an error (step S7).

In this preferred embodiment, an unconstrained object can be freely moved in virtual space as far as it does not interfere with another object. Even a constrained object can be moved within a range which does not violate a constraint condition if it does not interfere with another object. Additionally, this interference checking capability can be also released. For example, on a scene where a nail is put in a timber, the timber (the first object) and the nail (the second object) actually interfere with each other. Therefore, the interference checking capability must be released when such a scene is created.

If the object operation instruction is determined not as an error in step S6, a “virtual space object move” process (hereinafter referred to simply as an object move process) is performed (step S8). This object move process is a process for moving a target object of an object operation instruction so as not to cause the target object to interfere with another object while making the interference checking by the interference detecting unit 18. Details of this object move process will be described later.

Then, it is determined whether or not a complementary instruction must be generated due to an occurrence of discontinuous scenes depending on a result of determining whether or not the discontinuous scenes are caused by executing the object operation instruction or the eye point operation instruction by the discontinuity detecting unit 26 in succession to step S5 where the user input is determined not to be the object operation instruction (determined to be the eye point operation instruction) or the process of step S8 (step S9). If it is determined that the complementary instruction must be generated, the complementary instruction generating unit 20 is invoked, and made to perform a complementary instruction generation process for resolving the discontinuous scenes (step S10).

The complementary instruction generated by the complementary instruction generation process is inserted in a corresponding operation instruction sequence (step S11), and the flow goes back to step S3. In the meantime, the instruction inserted in step S8 is stored in the corresponding instruction sequence within the operation instruction storing unit 12 via the instruction sequence selecting unit 13 (step S12). Also the object operation instruction or the eye point operation instruction, for which generation of a complementary instruction is determined not to be required in step S9, is stored in the corresponding instruction sequence within the operation instruction storing unit 12 via the instruction sequence selecting unit 13 (step S12).

Here, additional explanation on the processes in steps S10 to S12 is provided. Suppose that an instruction X0 input by the user is inserted between instructions A and B in an operation instruction sequence, and discontinuous scenes occur during the execution of the instructions A and X0, and during the execution of the instructions X0 and B in the complementary instruction generation process. In this case, the complementary instruction generating unit 20 generates complementary instructions X1 and X2 respectively between the instructions A and X0, and between the instructions X0 and B. The instruction X0 input by the user is stored in the operation instruction storing unit 12 at this time (step S12), whereas the complementary instructions X1 and X2, which are generated by the complementary instruction generating unit 20, are inserted in the corresponding operation instruction sequence (step S11), and the flow goes back to step S3. The process is recursively repeated until it is determined that scenes before and after an inserted instruction are determined not to be discontinuous (discontinuous scenes do not occur before and after the execution of the inserted instruction).

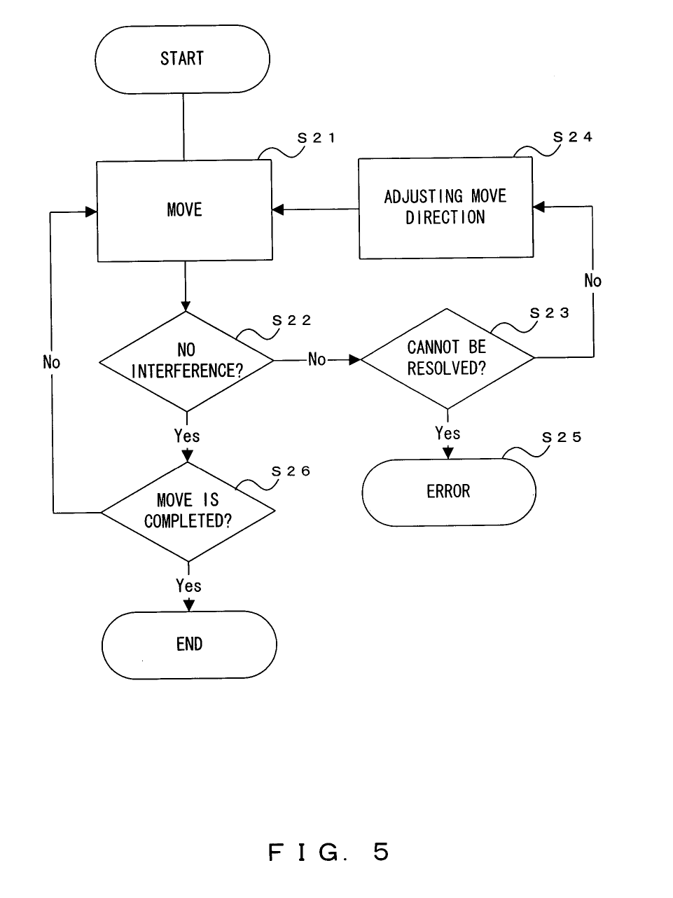

FIG. 5 is a flowchart showing the details of the object move process performed in step S8 of the flowchart shown in FIG. 4.

Firstly, a target object is moved in virtual space according to an object operation instruction (step S21). The interference detecting unit 18 determines whether or not interference with another object occurs based on the position information of each object within the three-dimensional model storing unit 11, if the target object is moved (step S22).

If the interference is determined to occur, the interference avoiding unit 19 determines whether or not the interference can be resolved (step S23). If the interference avoiding unit 19 determines that the interference can be resolved, it adjusts the move direction of the target object (step S24), and the flow goes back to step S21. In step S21, the object operating unit 15 moves the target object in the move direction adjusted in step S24.

In the meantime, if the interference avoiding unit 19 determines that the target object cannot be moved without causing interference with another object in step S23, the object operation instruction input by the user is determined as an error (step S25).

If the interference detecting unit 18 determines that the interference with another object does not occur when the target object is moved in step S22, the object operating unit 15 determines whether or not the move of the target object is completed (step S26). If the move of the target object is determined not to be completed (step S26), the flow goes back to step S21. Or, if the object operating unit 15 determines that the move of the object is completed in step S26, the process is terminated.

As described above, a target object is moved without causing interference with another object due to the move, if the target object is moved by executing an object operation instruction. In this case, if the interference does not occur when the object operation instruction is executed unchanged, this object operation instruction is stored in the corresponding instruction sequence within the operation instruction storing unit 12. However, if the interference occurs by executing the object operation instruction, the move direction of the target object is adjusted to avoid the interference. If the interference is resolved by adjusting the move direction, the move direction of the object operation instruction input by the user is changed to that obtained by the adjustment, and the object operation instruction whose move direction is changed is stored in the corresponding instruction sequence within the operation instruction storing unit 12.

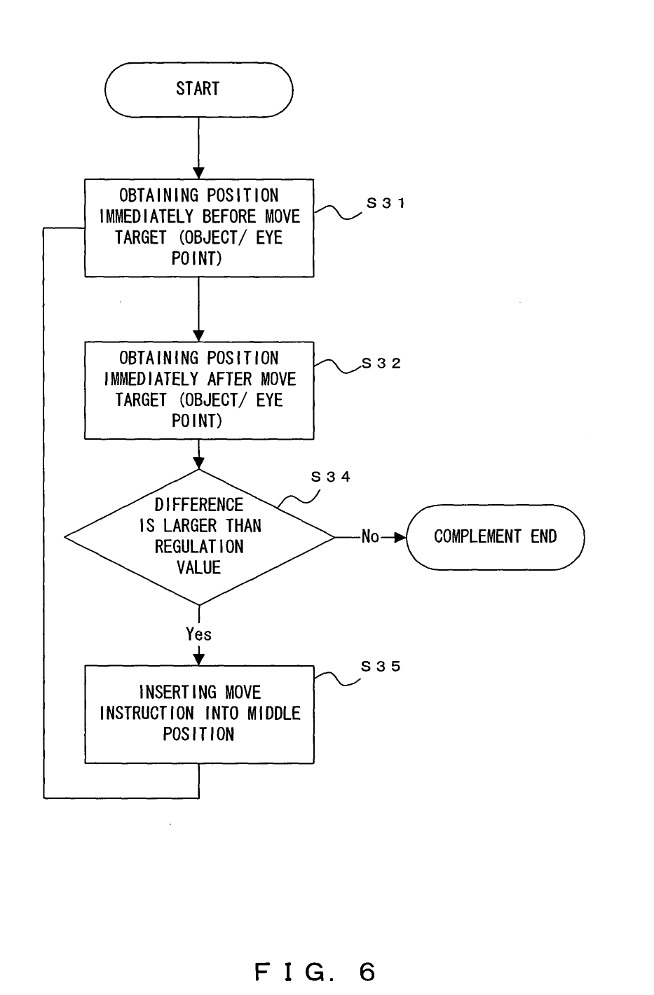

FIG. 6 is a flowchart showing the details of the complementary instruction generation process performed in step S10 of the flowchart shown in FIG. 4.

The complementary instruction generating unit 20 first obtains the position of a move target (object or eye point) immediately before a move (step S31), and obtains the position immediately after the move (step S32).

Then, the complementary instruction generating unit 20 obtains a difference between the position of the move target immediately before the move and that of the move target immediately after the move, and determines whether or not the difference is larger than a regulation value (step S34). If the difference is larger than the regulation value, an instruction to move the move target to a middle position between the position immediately before the move and that immediately after the move is inserted (step S35). The flow then goes back to step S31.

If the difference is equal to or smaller than the regulation value in step S34, the complementary process is terminated.

In this way, a move instruction to resolve discontinuity (an object move instruction or an eye point move instruction) is automatically generated/inserted in a corresponding instruction sequence by the number of scenes that do not make scenes discontinuous, when an object operation instruction or an eye point operation instruction by which the scenes become discontinuous is executed.

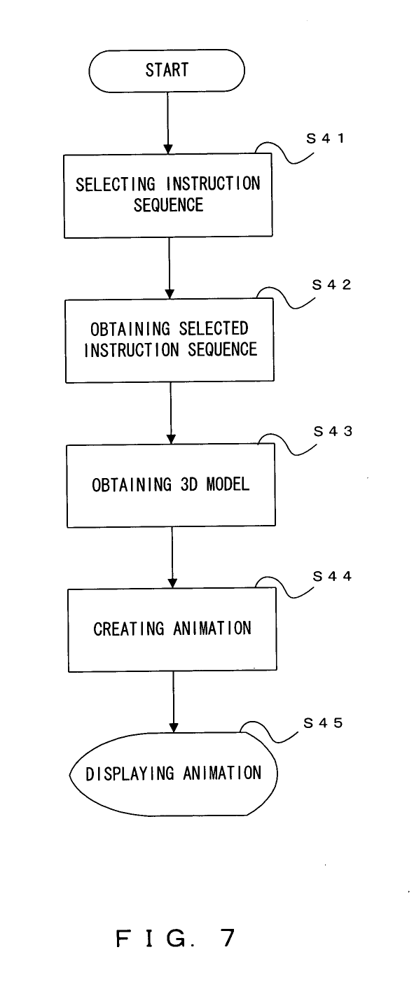

FIG. 7 is a flowchart explaining an animation replay (display) process performed by the animation editing system 10 according to the preferred embodiment.

The process represented by this flowchart is performed in such a way that a user inputs an instruction to replay a certain animation via the operation inputting unit 22.

The instruction sequence selecting unit 13 selects the instruction sequence corresponding to the animation specified by the user from the operation instruction storing unit 12 (step S41). The image creating unit 23 obtains the instruction sequence selected by the instruction sequence selecting unit 13 (step S42), and also obtains the three-dimensional model information of an object to be operated by each of operation instructions in the instruction sequence from the three-dimensional model storing unit 11 (step S43). Then, the image creating unit 23 creates an animation image while sequentially executing the series of operation instructions in the instruction sequence (step S44). The image creating unit 23 uses the three-dimensional model information of the object to be operated when executing the operation instructions.

The image creating unit 23 makes the animation displaying unit 25 display the created animation image (step S45).

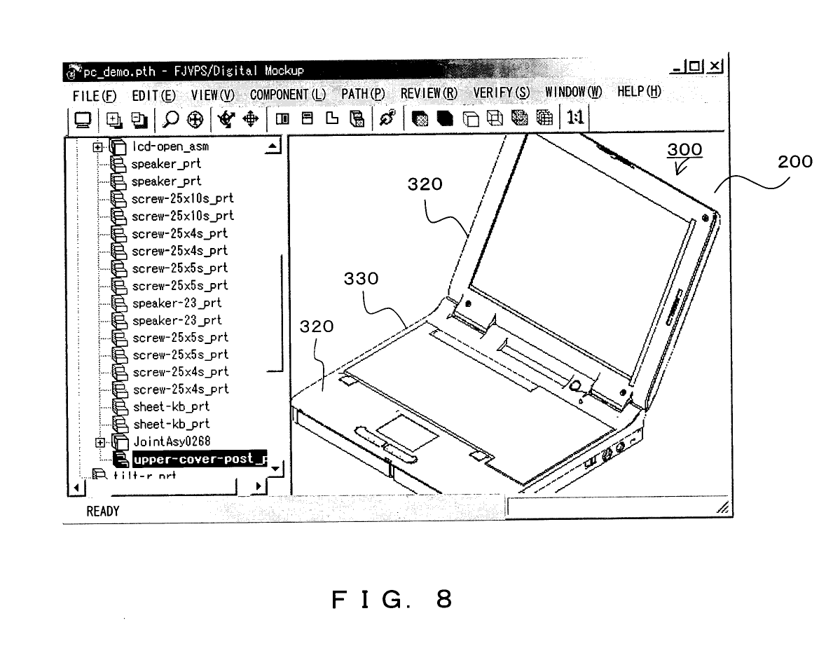

Object operations of various types, which can be performed by the animation editing system 10, are explained next. The following explanation refers to examples where an image 200, in which a notebook PC 300 is arranged as an object in virtual space as shown in FIG. 8, is used as an original image, and the operations of various types are performed for the original image 200.

[Eye Point Move]

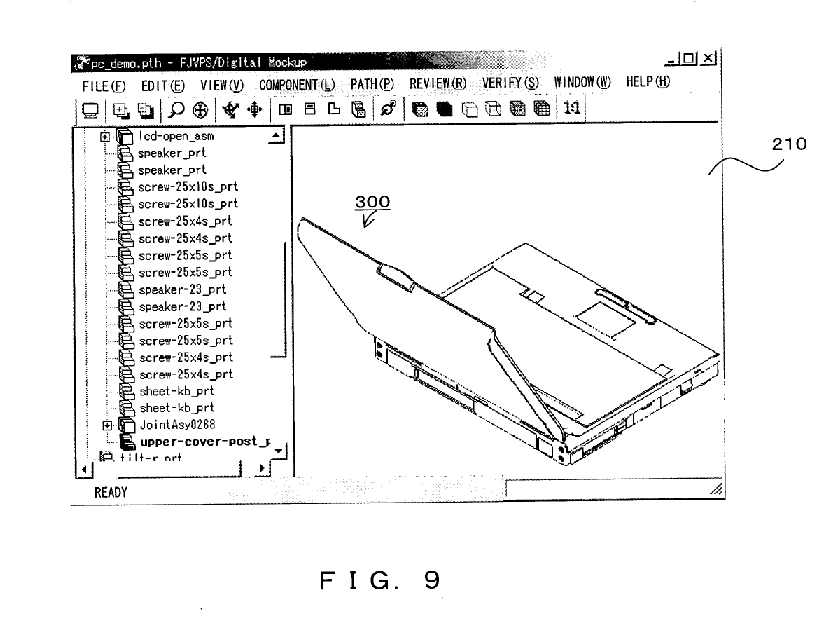

An eye point move operation for the notebook PC 300 is performed for the original image 200 shown in FIG. 8, so that an image 210 in which the notebook PC 300 is viewed from the back side can be created as shown in FIG. 9.

[Display Attribute Change]

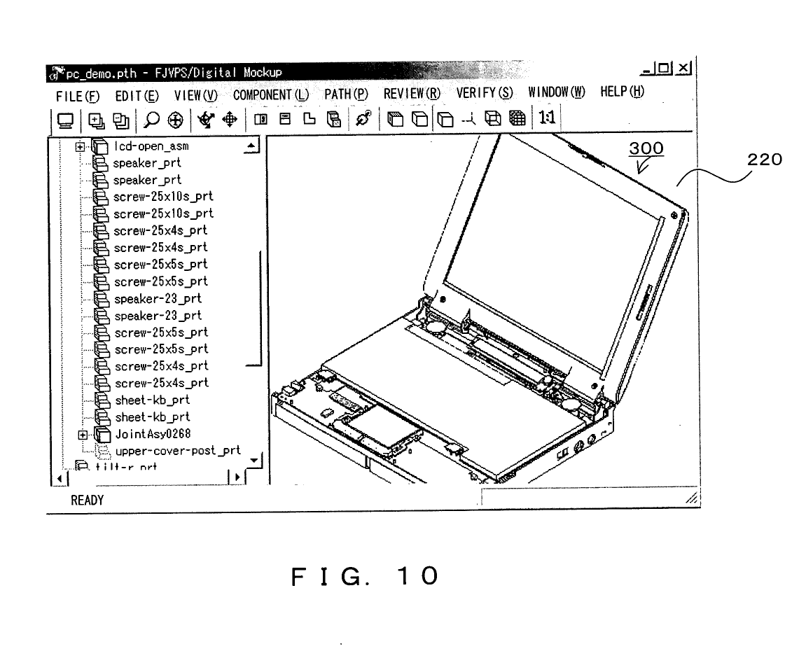

A display attribute change operation for nondisplaying an upper cover 310 of the body of the notebook PC 300 is performed for the original image 200 shown in FIG. 8, so that an image 220 in which the upper cover 310 is not displayed, and the inside hidden by the cover 310 is displayed can be created as shown in FIG. 10.

[Object Rotation]

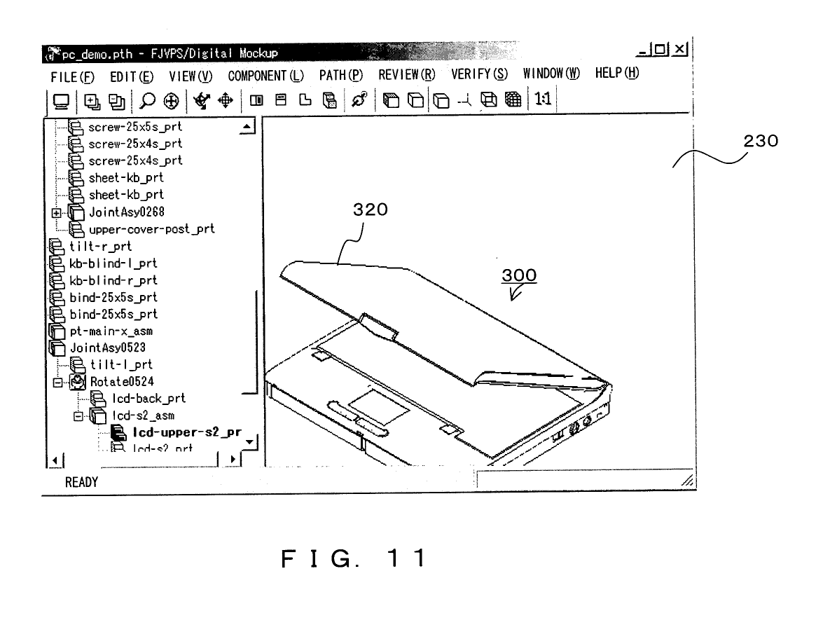

An object rotation operation is performed for the original image 200 shown in FIG. 8, so that an image 230 in which an LCD (Liquid Crystal Display) unit 320 of the notebook PC 300 is rotated in a closing direction can be created as shown in FIG. 11.

[Constraint Release]

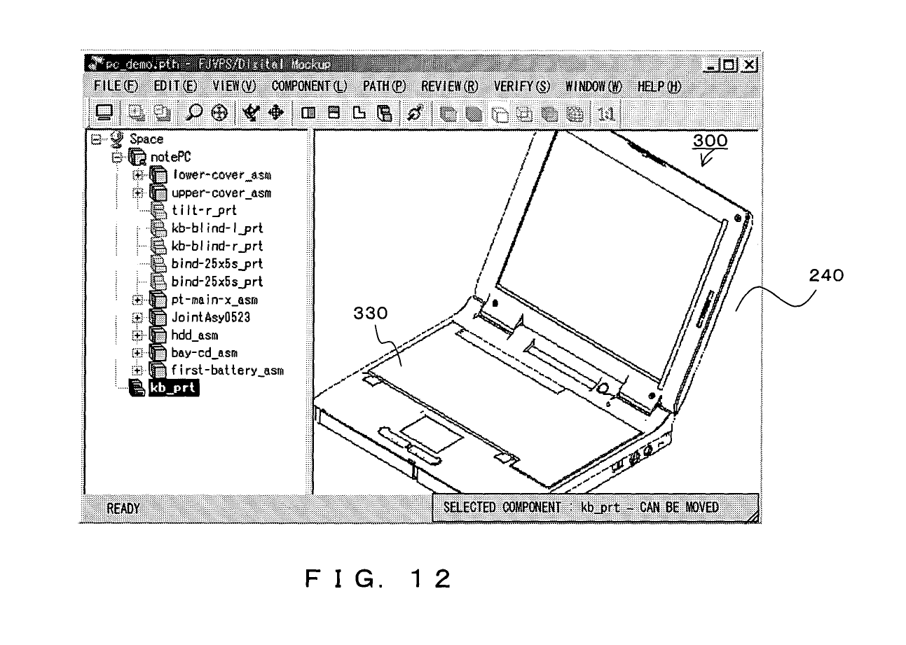

An operation for releasing a keyboard 330 from the constraint of the notebook PC 300 is performed for the original image 200 shown in FIG. 8, so that an image 240 in which the keyboard 330 is disassembled from the notebook PC 300 can be created as shown in FIG. 12 (an object of the keyboard 300 can be removed from the object tree of the notebook PC 300, which is stored in the three-dimensional model storing unit 11).

[Object Move]

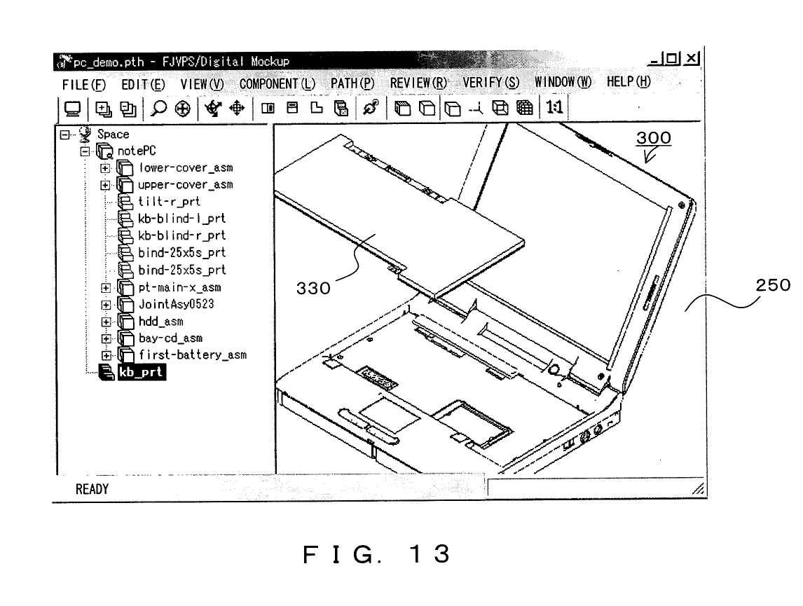

An object move operation is performed for the image 240 shown in FIG. 12, so that an image 250 in which the keyboard 330 disassembled in FIG. 12 is moved upward can be created as shown in FIG. 13.

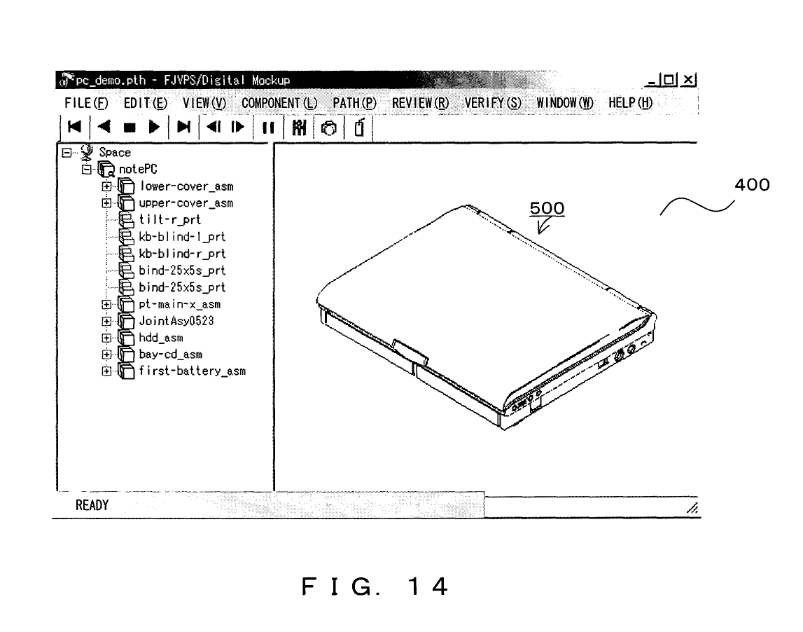

A specific example in which an animation is created with the process represented by the flowchart shown in FIG. 4 is explained with reference to FIGS. 14 to 35.

This specific example takes an animation that disassembles a notebook PC.

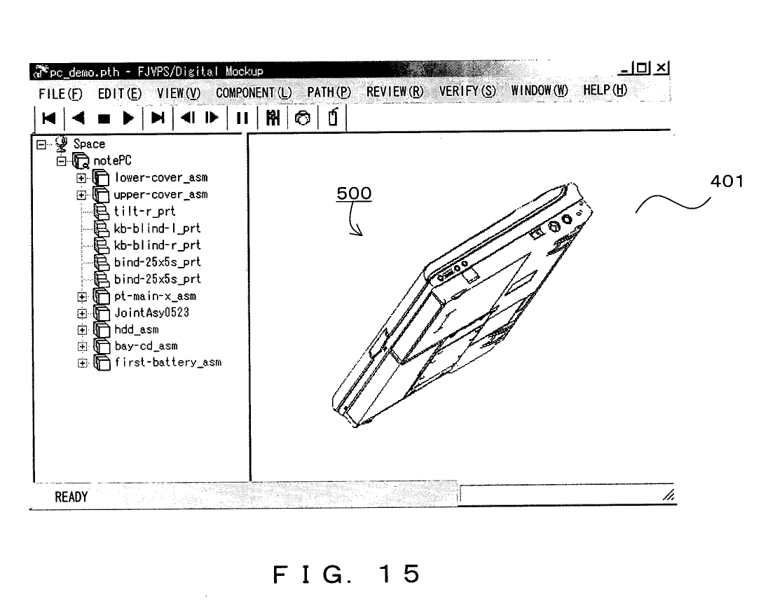

With a user input from the operation inputting unit 22, the image creating unit 23 reads the three-dimensional model information of the object of the notebook PC from the three-dimensional model storing unit 11, and makes the animation displaying unit 25 display an image 400 in which the notebook PC 500 shown in FIG. 14 appears. Images that are shown in FIGS. 15 to 36 and described below are images that the image creating unit 23 displays on the animation displaying unit 25. Additionally, operation instructions for the image (object) of the notebook PC in the respective images are input from the user via the operation inputting unit 22.

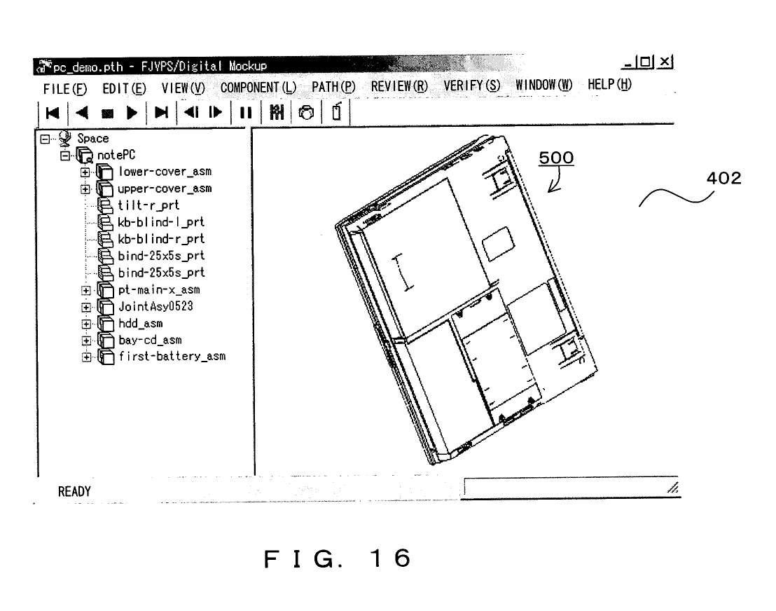

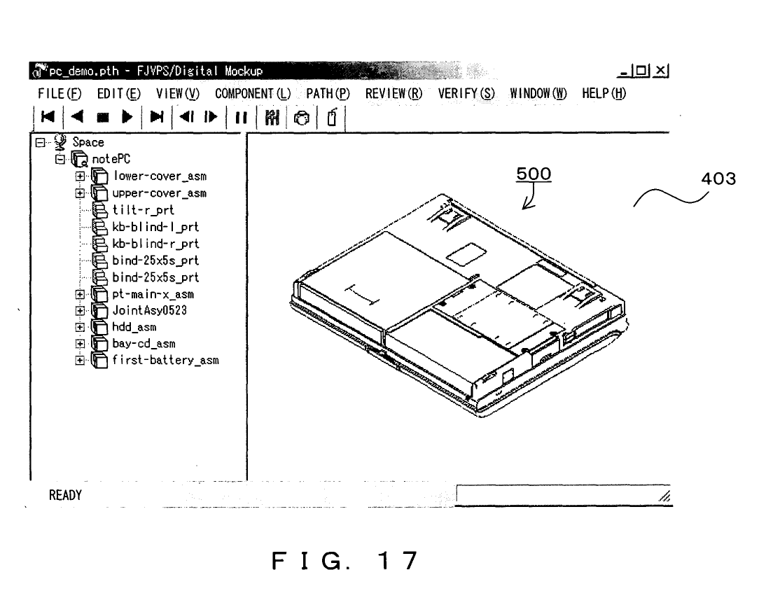

If an eye point move instruction to move the eye point for the notebook PC 500 to the back side is input for the image 400 shown in FIG. 14, two images 401 and 402, which are shown in FIGS. 15 and 16, are displayed before an image 403 shown in FIG. 17 is displayed. The eye point move instruction to display the images 401 and 402 is complemented by the complementary instruction generating unit 20. This is implemented by the processes in steps S8 to S11 of the flowchart shown in FIG. 4.

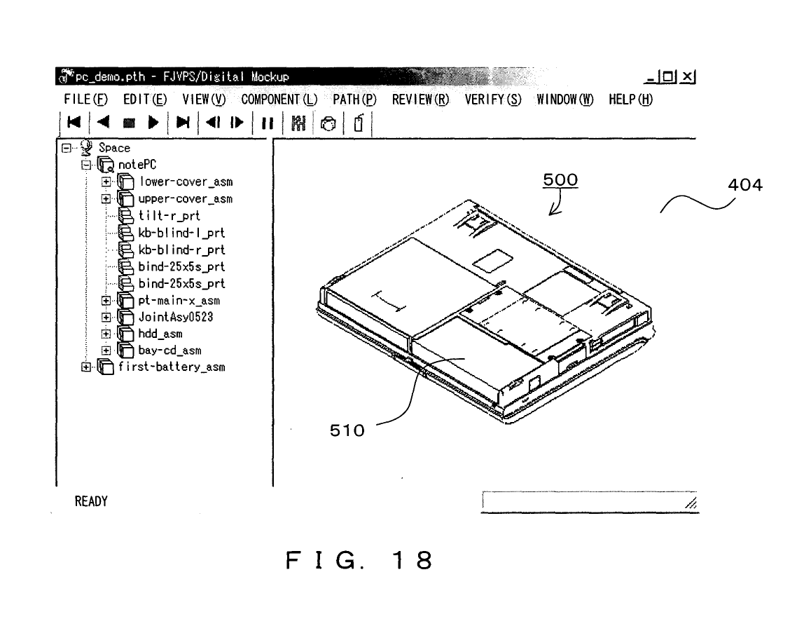

If an instruction to delete (release) a constraint of an object of a battery 510 of the notebook PC 500 from the object of the notebook PC 500 is input for the image 403 shown in FIG. 17, the object of the battery 510 is removed from the object tree of the notebook PC 500. An image 404 shown in FIG. 18 is an image that is in a state where the object of the battery 510 is disassembled from the object of the notebook PC 500.

Whether or not the constraint of the battery 510 can be deleted is determined in step S6 of the flowchart shown in FIG. 4.

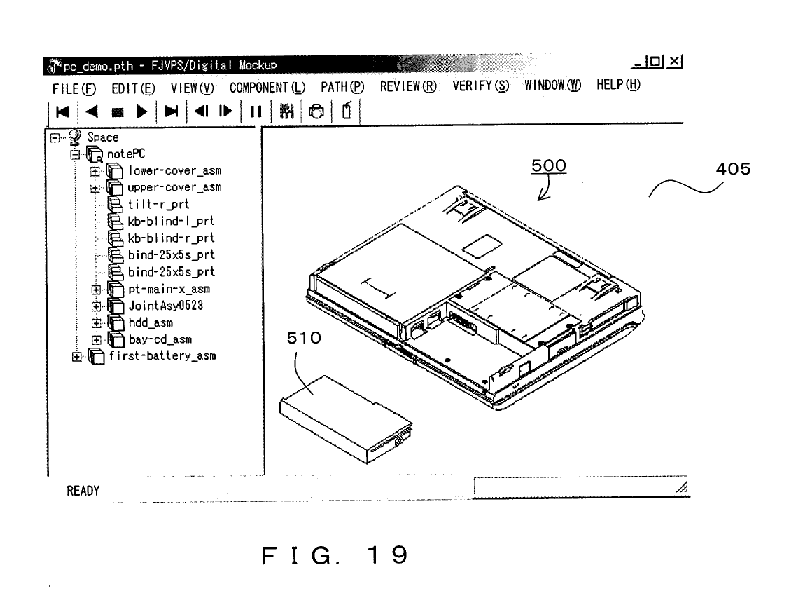

If an object move instruction to move the battery 510 in the lower left direction is input for the image 404 shown in FIG. 18, an image 405 in which the battery 510 is removed from the main body of the notebook PC 500, and the position of the battery 510 is moved in the lower left direction is displayed as shown in FIG. 19. The move of this battery 510 is made in step S8 of the flowchart shown in FIG. 4.

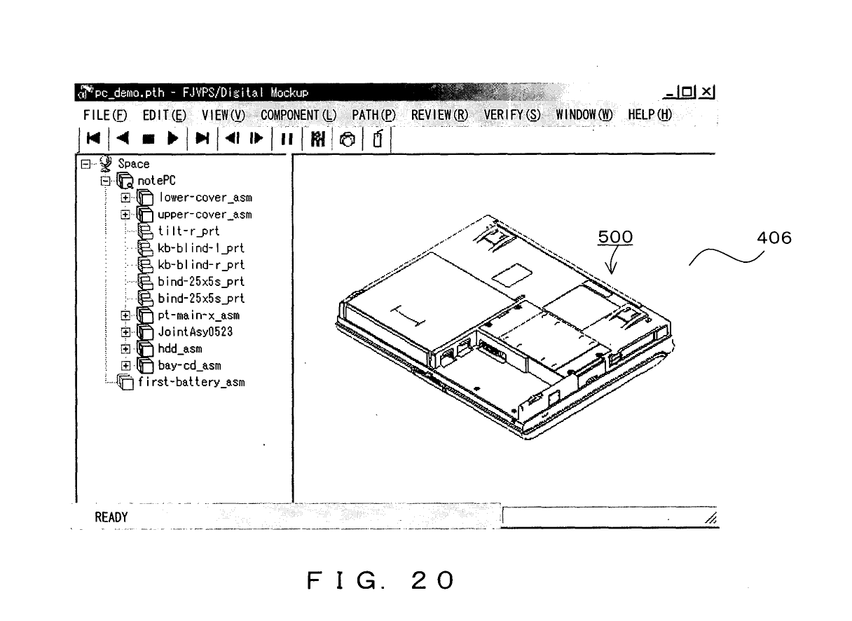

If an operation instruction to nondisplay the display attribute of the object of the battery 510 is input for the image 405 shown in FIG. 19, an image 406 in which the battery 510 disappears from the image 405 is displayed as shown in FIG. 20.

If an instruction to delete the constraint of an object of a CD (Compact Disc) 520 from the object of the notebook PC 500 is input for the image 406 shown in FIG. 20, the object of the CD 520 is removed from the object tree of the notebook PC 500.

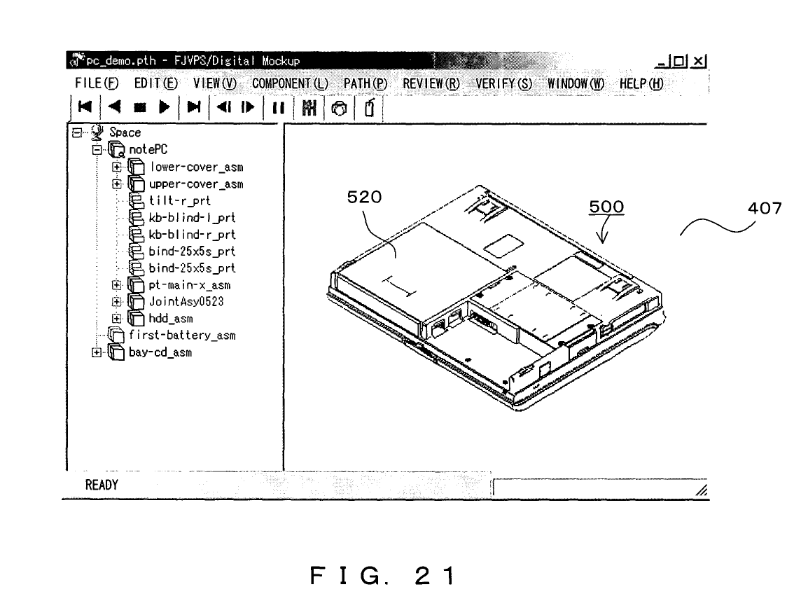

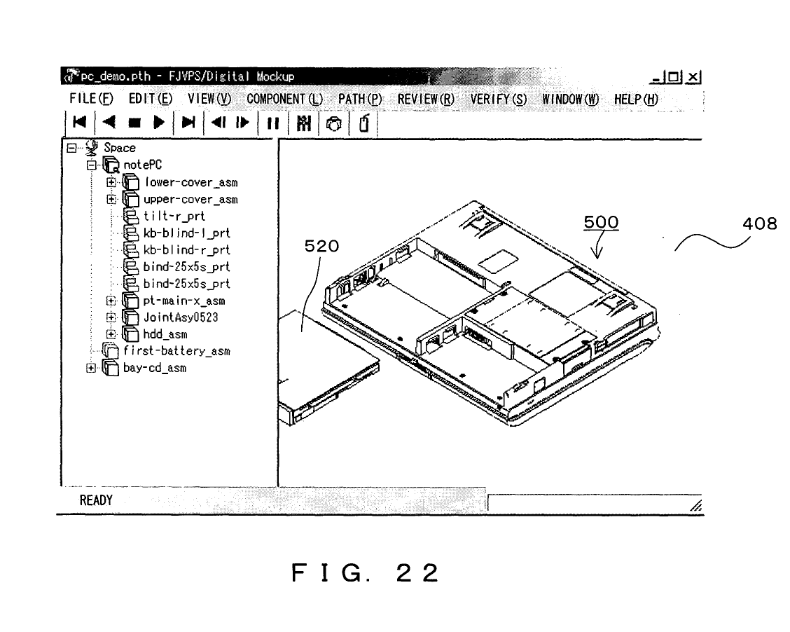

If an object move instruction to move the CD 520 in the lower left direction is input for an image 407 shown in FIG. 21, an image 408 in which the CD 520 is removed from the main body of the notebook PC 500, and moved in the lower left direction is displayed as shown in FIG. 22.

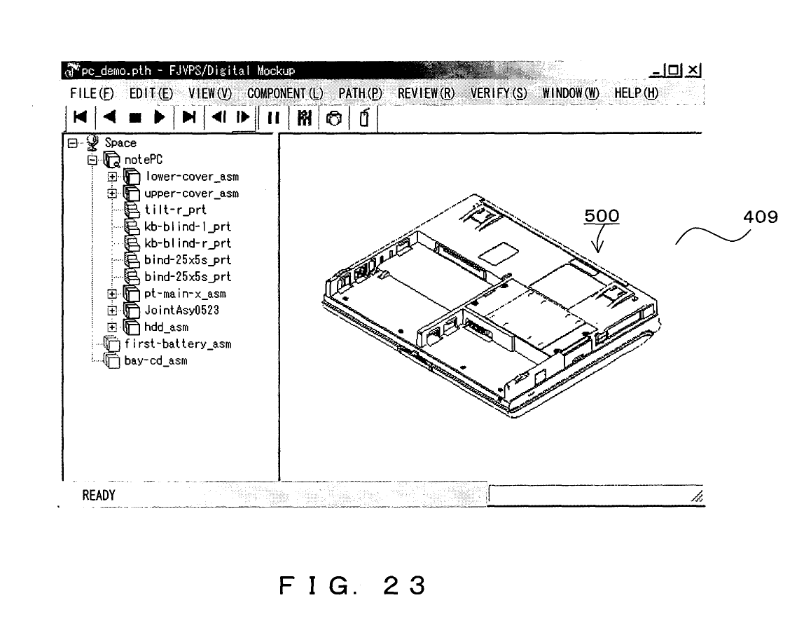

If a display attribute change instruction to nondisplay the object of the CD 520 is input for the image 408 shown in FIG. 22, an image 409 in which the CD 520 is erased from the image 408 is displayed as shown in FIG. 23.

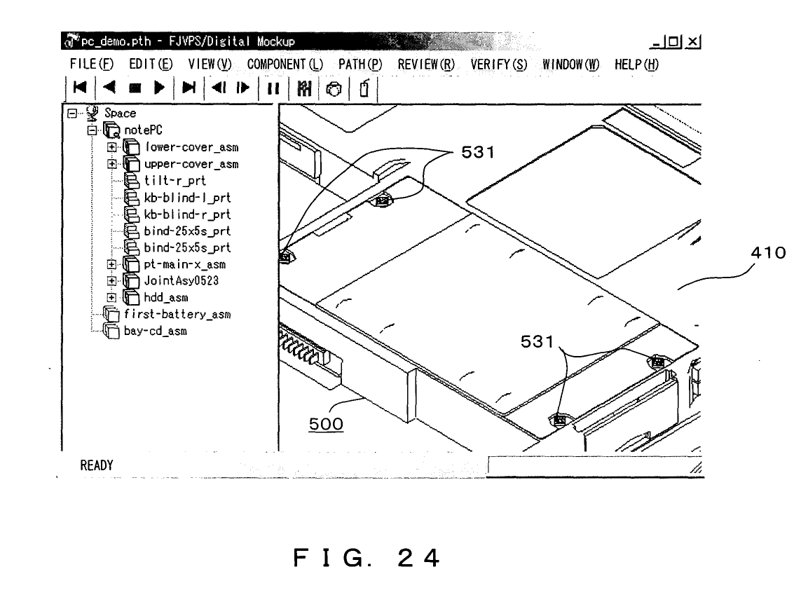

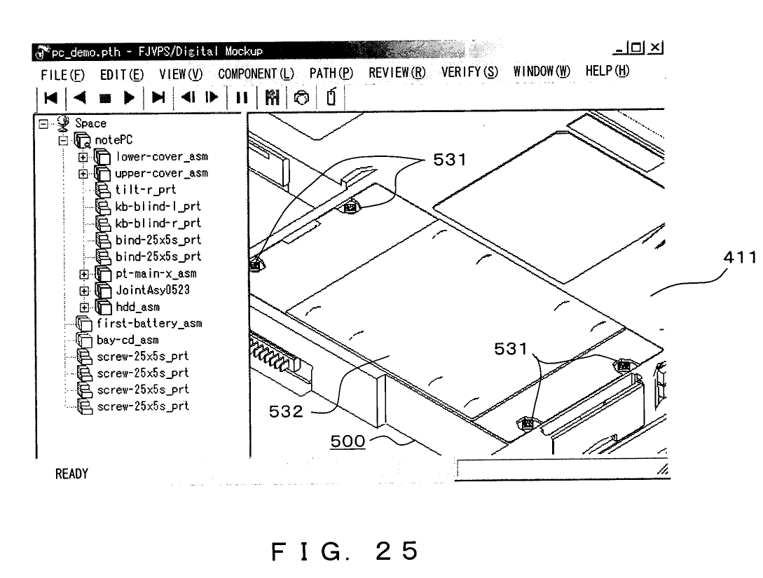

If an eye point zoom-in instruction is input for the image 409 shown in FIG. 23, an image 411 shown in FIG. 25, in which the image size of the notebook PC 500 displayed in the image 409 is enlarged with the zoom magnification specified by the above described eye point zoom-in instruction, is displayed as shown in FIG. 24.

If a constraint deletion instruction to delete objects of four screws 531 which fix the cover 532 of an HDD (Hard Disk Drive) from the constraint of the object of the notebook PC 500 is input for the image 410 shown in FIG. 24, the objects of the four screws 531 are removed from the object of the notebook PC 500. Then, the image 411 shown in FIG. 25 is displayed.

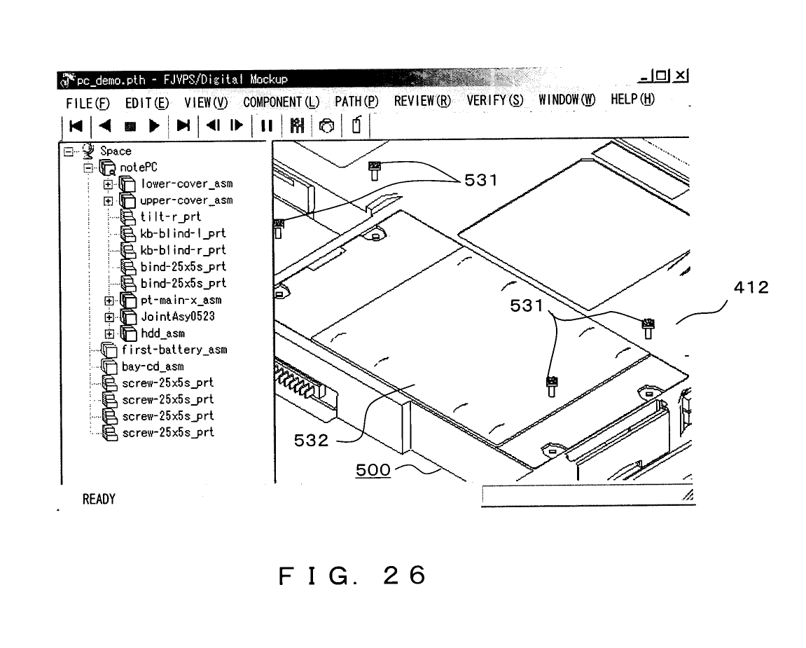

If an object move instruction to move the four screws 531 in the perpendicular direction is input for the image 411 shown in FIG. 25, an image 412 in which the four screws 531 which fix the HDD cover 532 of the notebook PC 500 are removed, and moved in the perpendicular direction by the distance specified by the object move instruction is displayed as shown in FIG. 26.

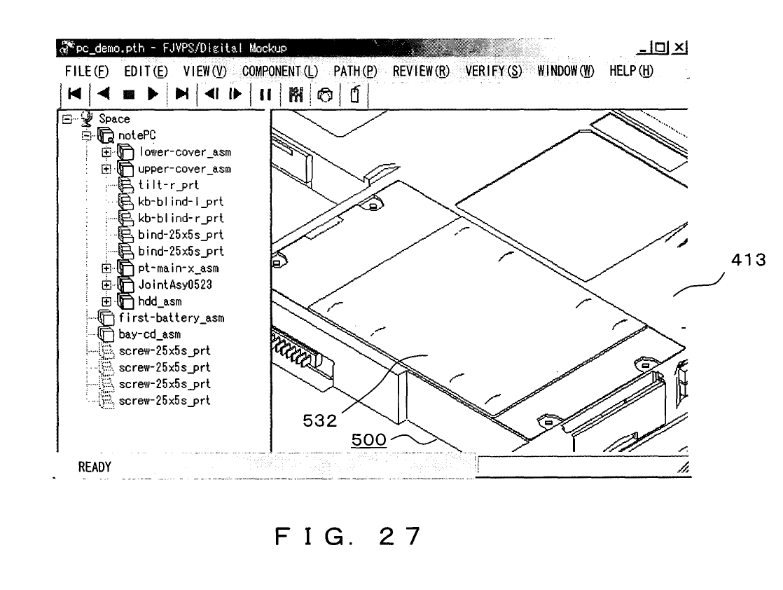

If an attribute change instruction to nondisplay the display attributes of the objects of the four screws 531 is input for the image 412 shown in FIG. 26, an image 413 in which the four screws 531 are erased from the image 412 is displayed as shown in FIG. 27.

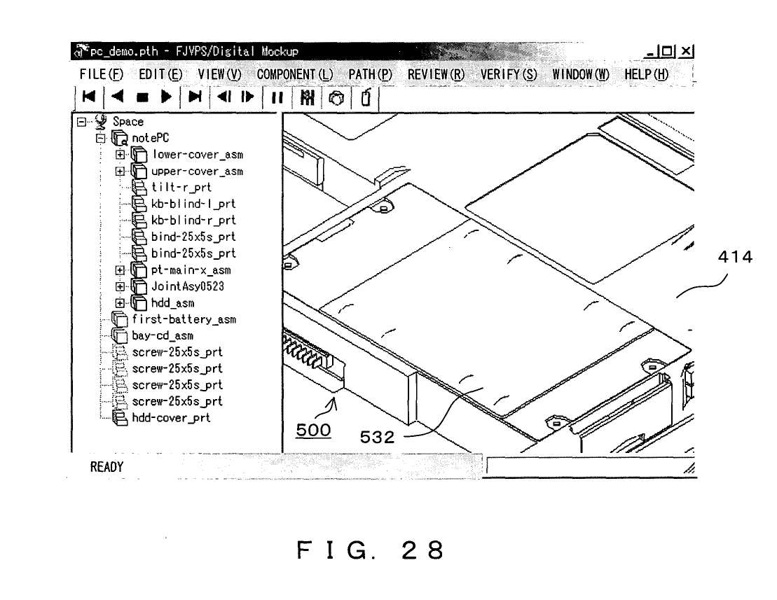

If a constraint deletion instruction to delete the object of the HDD cover 532 from the constraint of the object of the notebook PC 500 is input for the image 413 shown in FIG. 27, an image 414 in which the object of the HDD cover 532 is deleted from the constraint of the object of the notebook PC 500 is displayed as shown in FIG. 28. At this time, the object of the HDD cover 532 is deleted from the object tree of the notebook PC 500.

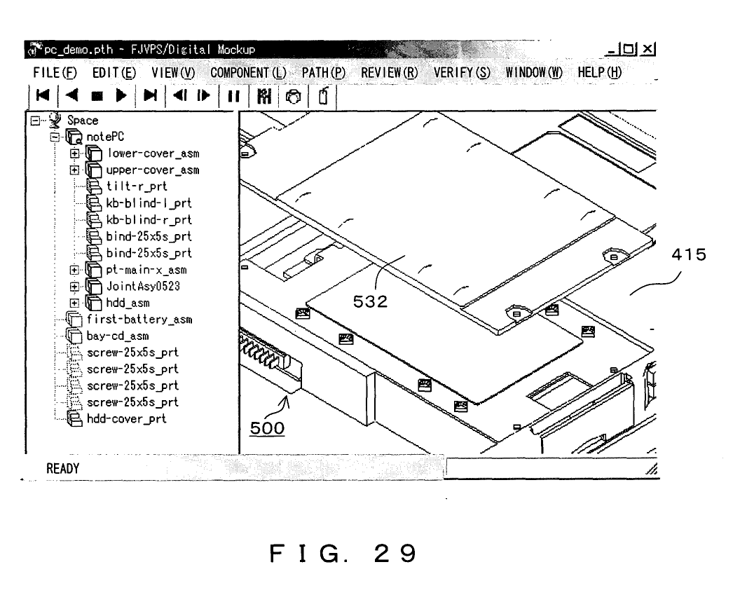

If an object move instruction to move the HDD cover 532 upward is input for the image 414 shown in FIG. 28, an image 415 in which the HDD cover 532 is moved above the main body of the notebook PC 500 is displayed as shown in FIG. 29.

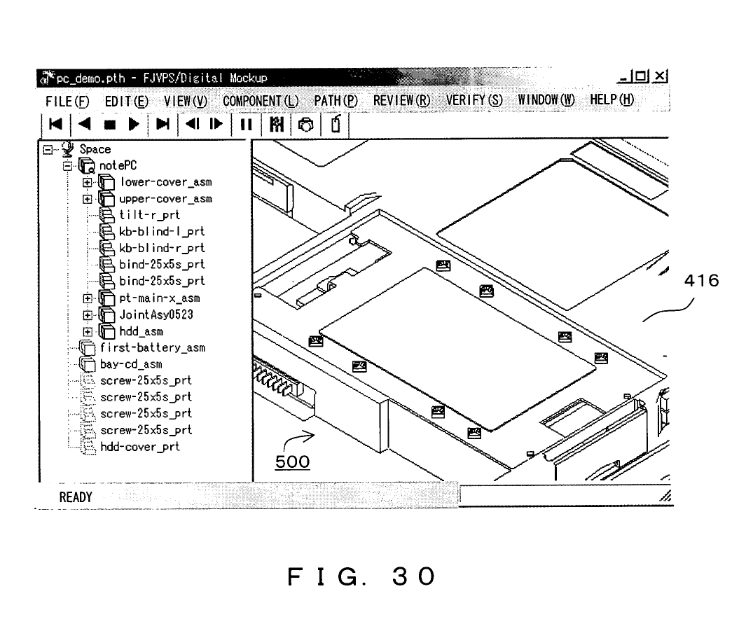

If a display attribute change instruction to nondisplay the display attribute of the object of the HDD cover 532 is input for the image 415 shown in FIG. 29, an image 416 in which the HDD cover 532 is erased from the image 415 is displayed as shown in FIG. 30.

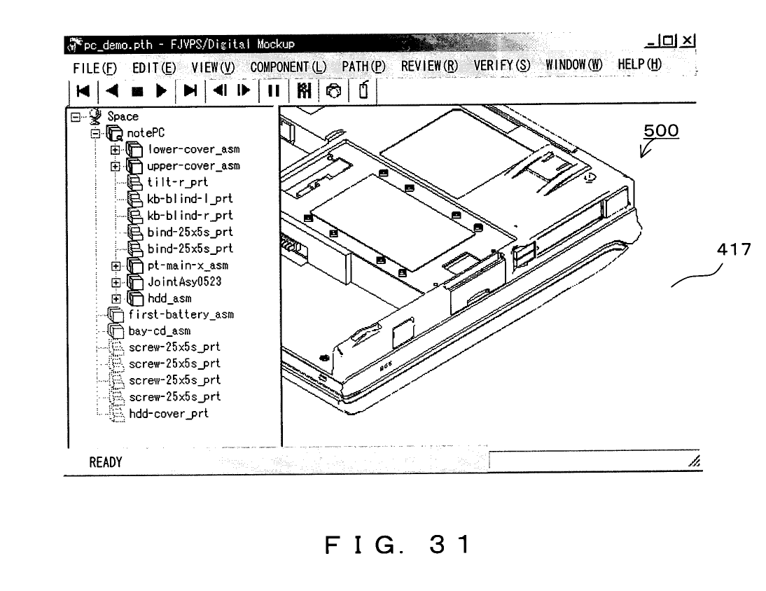

If an eye point move instruction to change the eye point for the notebook PC 500 to its right side direction is input for the image 416 shown in FIG. 30, an image 417 in which the eye point for the notebook PC 500 exists in the center of the right side is displayed as shown in FIG. 31.

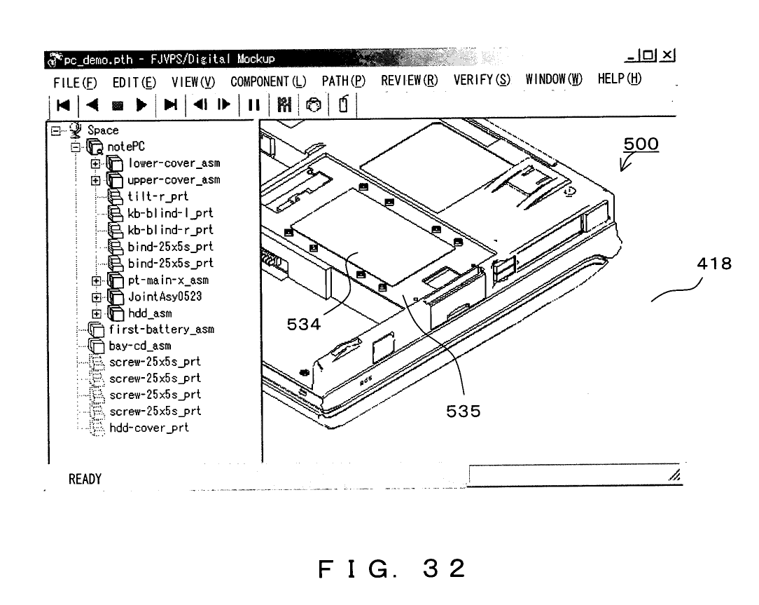

If a constraint deletion instruction to delete the constraint of the object of the HDD unit 534 from the object of the notebook PC 500 is input for the image 417 shown in FIG. 31, an image 418 in which the constraint of the object of the HDD unit 534 is deleted from the object of the notebook PC 500 is displayed as shown in FIG. 32.

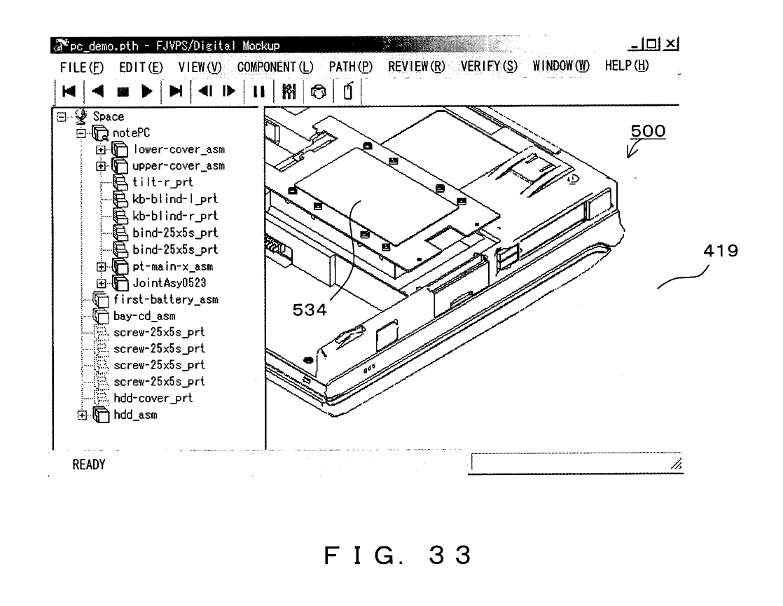

If the user inputs an object move instruction to move the HDD unit 534 just horizontally for the image 418 shown in FIG. 32, the interference detecting unit 18 detects that the HDD unit 534 interferes with a right side portion 535 of an accommodating unit of the HDD unit 534 of the notebook PC 500 when the HDD unit 534 is moved just horizontally. Accordingly, an object move instruction to move the HDD unit 534 upward is created/executed by the interference avoiding unit 19 (the process in step S8 of the flowchart shown in FIG. 4). As a result, an image 419 in which the HDD unit 534 is moved above the notebook PC 500 is displayed as shown in FIG. 33.

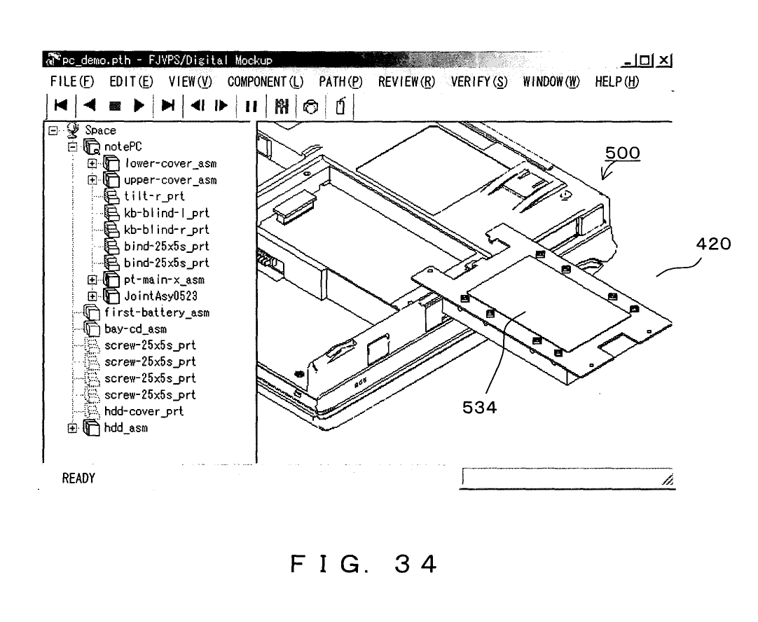

The object move instruction to move the HDD unit 534 just horizontally, which is input by the user for the image 418, is then executed for the image 419 shown in FIG. 33, so that an image 420 in which the HDD unit 534 is moved just horizontally above the notebook PC 500 is displayed as shown in FIG. 34.

Since the move of the HDD unit 534 in the image 420 is not the object move instruction input by the user, an image 422 in which the HDD unit 534 included in the notebook PC 500 is moved just horizontally from the position in which the HDD unit 534 is originally included is displayed. This image 422 is an image according to the user instruction, and automatically generated by the system.

As described above, in this preferred embodiment, when a target object is moved according to an object move instruction specified by a user, the target object is moved by changing its move direction so as to avoid interference if the target object interferes with another object. Then, the target object is moved in the direction according to the user instruction.

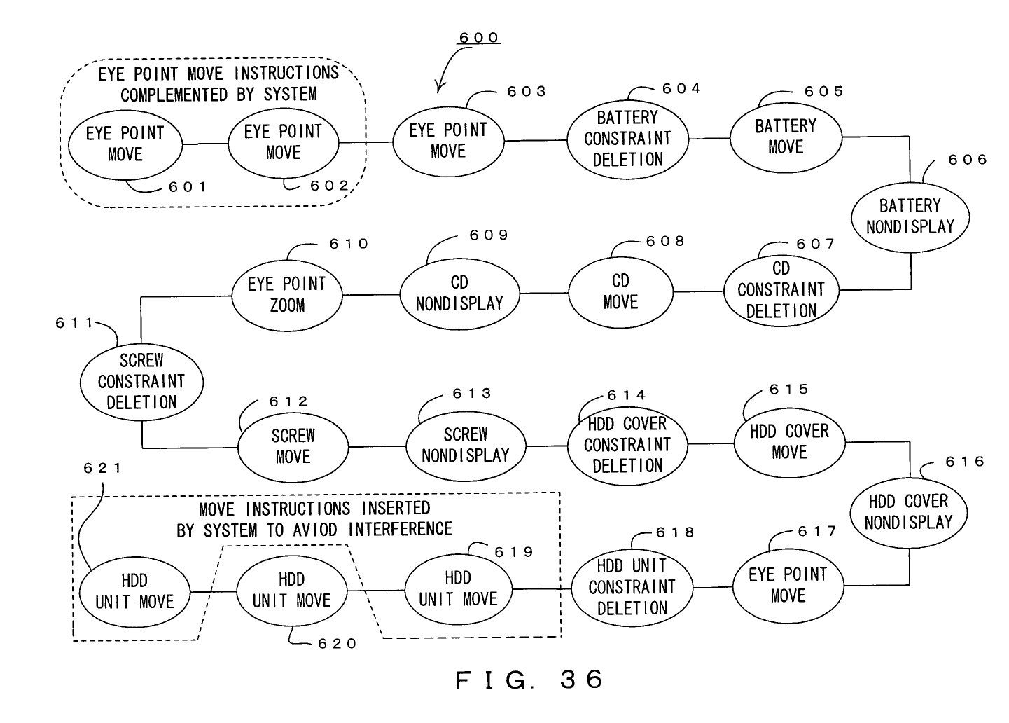

FIG. 36 shows an operation instruction sequence generated while an animation including the images 401 to 422, which are shown in FIGS. 15 to 35, as scenes is created. The operation instruction sequence 600 shown in FIG. 36 is stored in the operation instruction storing unit 12 via the instruction sequence selecting unit 13. In this figure, instructions enclosed by broken lines are instructions complemented or inserted by the system.

When an eye point move instruction 603 is input for the image 400 shown in FIG. 14, eye point move instructions 601 and 602 are automatically generated by the system before an eye point move instruction 603 (an instruction to display the image 403 shown in FIG. 17) so as to complement the images 401 and 402, which are shown in FIGS. 15 and 16. Accordingly, the initial portion of the operation instruction sequence 600 becomes the eye point move instructions 601 to 603.

Then, a battery constraint deletion instruction 604, a battery move instruction 605, and a display attribute change instruction (battery nondisplay instruction) 606, which are input to display the images 404 to 406 shown in FIGS. 18 to 20, are appended after the eye point move instruction 603.

Next, a CD constraint release instruction 607, a CD move instruction 608, and a display attribute change instruction (CD nondisplay instruction) 609, which are input to display the images 407 to 409 shown in FIGS. 21 to 23, are appended after the battery nondisplay instruction 606.

Then, an eye point zoom instruction 610, a screw constraint deletion instruction 611, a screw move instruction 612, a display attribute change instruction (screw nondisplay instruction) 613, an HDD cover constraint deletion instruction 614, an HDD cover move instruction 615, a display attribute change instruction (HDD cover nondisplay instruction) 616, an eye point move instruction 617, and an HDD unit constraint deletion instruction 618, which are input to display the images 410 to 417 shown in FIGS. 24 to 32, are appended after the CD nondisplay instruction 609.

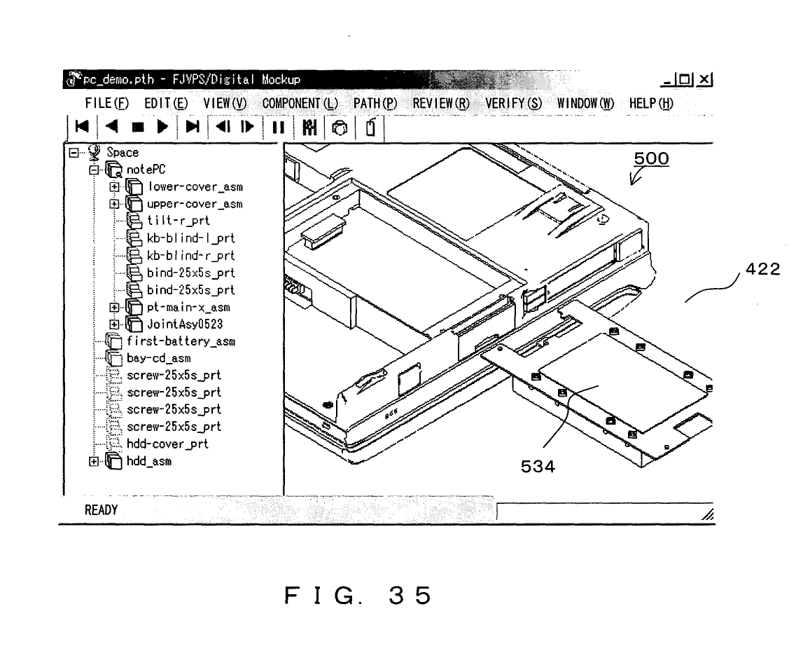

Next, an HDD unit move instruction 620 to move the HDD unit 534 just horizontally as in the image 422 shown in FIG. 35 is input when the image 417 is displayed. In this case, if the HDD unit 534 is moved just horizontally unchanged, it interferes with part of the notebook PC 500 as described above. Therefore, an HDD unit move instruction 619 to generate the image 419 in which the HDD unit 534 is moved just upward is created by the interference avoiding unit 19 so as to avoid this interference, and this instruction 619 is appended after the HDD unit constraint deletion instruction 618. Then, the input HDD unit move instruction 620 is executed after the HDD unit move instruction 619, so that the image 420 shown in FIG. 34 is displayed.

To implement this, the HDD unit move instruction 620 is appended after the HDD unit move instruction 619 in the operation instruction sequence 600. Then, as shown in FIG. 35, the interference avoiding unit 19 appends an HDD unit move instruction 621 after the HDD unit move instruction 620 so as to create the image 422 in which the HDD unit 534 is moved just horizontally as the user originally desires as shown in FIG. 35.

In this way, the operation instruction sequence 600 for displaying the animation composed of the series of images 401 to 422 shown in FIGS. 15 to 35 is created by the user inputs and the animation editing system 10, and stored in the operation instruction storing unit 12.

Examples where an error is caused by an input of an object operation instruction are explained next.

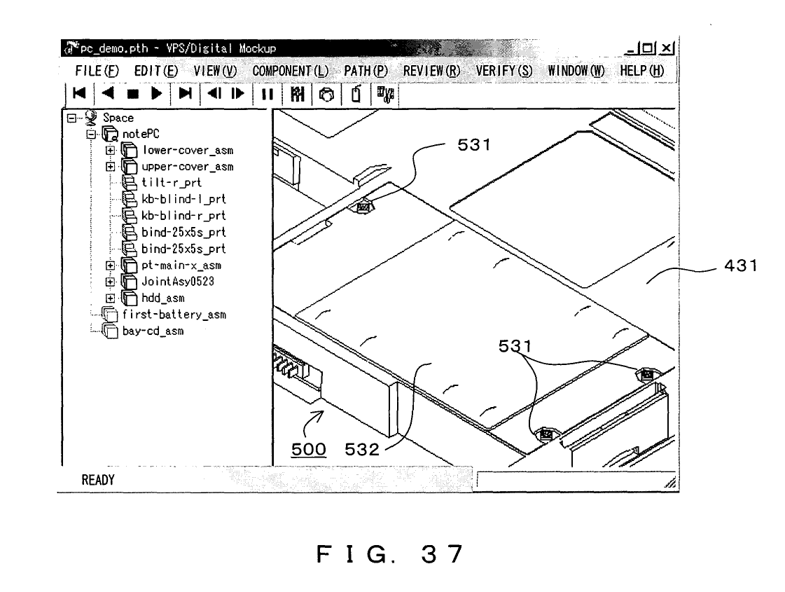

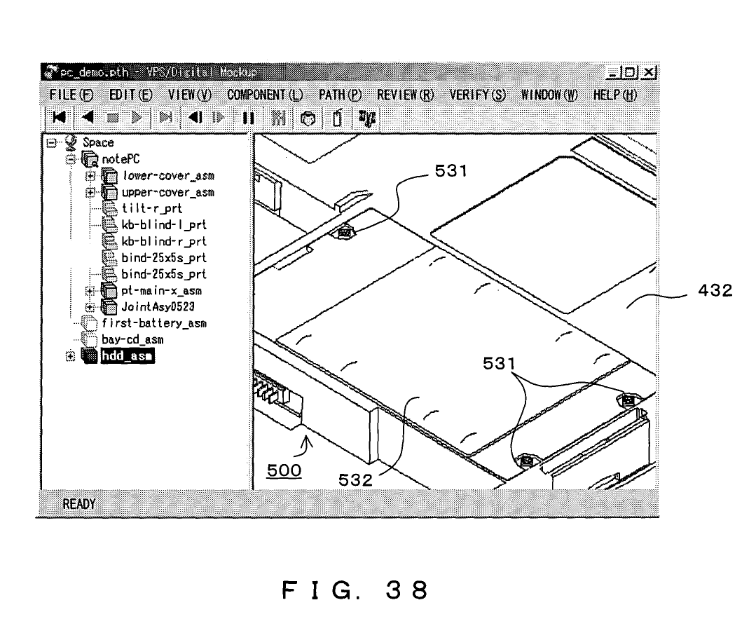

First of all, an example where an error is caused by an input of an object move instruction is explained with reference to FIGS. 37 and 38.

An image 431 shown in FIG. 37 is an image obtained by slightly zooming in the notebook PC 500 shown in the image 410 of FIG. 24. In the notebook PC 500 shown in this image 431, the HDD cover 532 is fixed with the four screws 531 (one screw 531 is not shown).

An instruction to delete the constraint of the object of the HDD unit 534 (not shown) from the object of the notebook PC 500 is input for the image 431. An image after this input is an image 432 shown in FIG. 38. If an object move instruction to move the HDD unit 534 is input in the state where this image 432 is displayed, this instruction is determined to be an error as a result of the interference checking made by the interference detecting unit 18, because the HDD cover 532 is not yet removed at this time point. Therefore, the HDD unit 534 cannot be moved.

An example where an error is caused by an input of an attribute change instruction in a movable range is explained next.

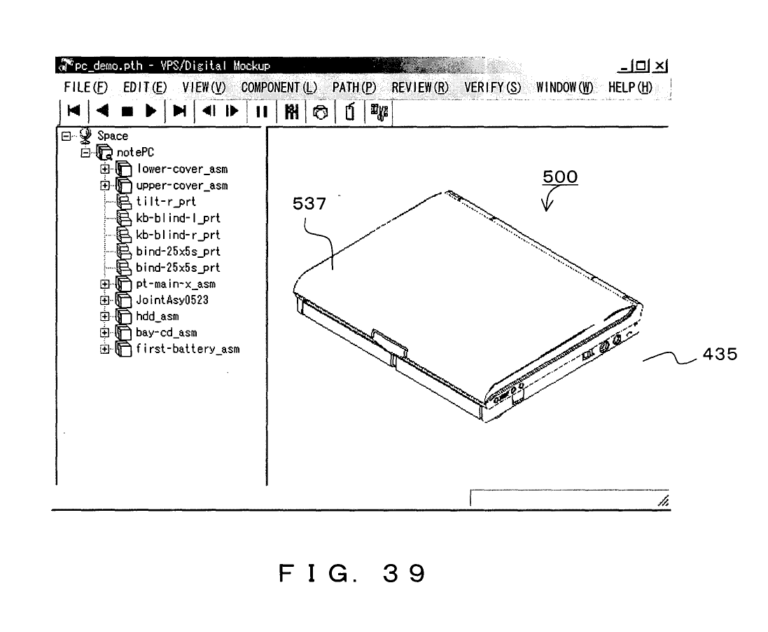

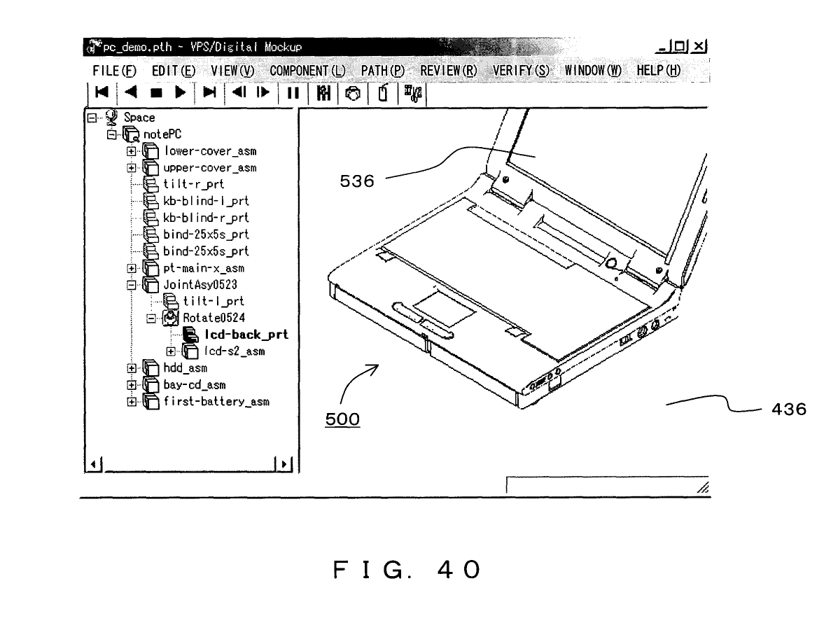

An image 435 shown in FIG. 39 is an image that represents the state of the notebook PC 500 whose cover 537 having an LCD unit 536 (not shown) is closed. Assume that the movable range of the LCD unit 536 is set (restricted) to 0 to 120 degrees. An object rotation instruction to rotate (open) the LCD unit 536 by 120 degrees is input in the state where the image 435 is displayed. As a result, an image 436 of the notebook PC 500 that is in the state where the LCD unit 536 is opened by 120 degrees is displayed as shown in FIG. 40.

If an attribute change instruction to change the movable range of the LCD unit 536 to 0 to 90 degrees is input in the state where the image 436 is displayed, the constraint detecting unit 17 detects that the LCD unit 536 is already open by 120 degrees, and determines the attribute change instruction as an error. Accordingly, the movable range of the LCD unit 536 cannot be changed in this case.

Additionally, there may be a case where a complementary instruction generated by the complementary instruction generating unit 20 becomes an error in this preferred embodiment. For example, if an object cannot be moved due to the reason that interference is caused by executing an object operation instruction generated as a complementary instruction, this object operation instruction becomes an error (see the flowchart shown in FIG. 5).

An example where interference can be avoided by generating a complementary instruction by the complementary instruction generating unit 20 when execution of an object operation instruction input by a user causes an interference error is explained next.

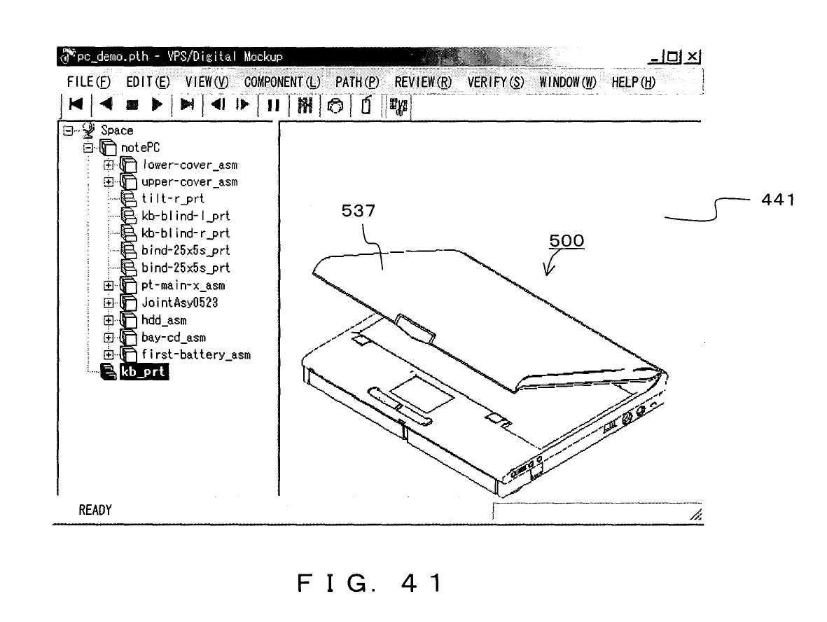

FIG. 41 shows a screen on which an image 441 representing the notebook PC 500 whose cover 537 is slightly open is displayed. Assume that an object operation instruction to move a keyboard 538 upward is input for the image 441.

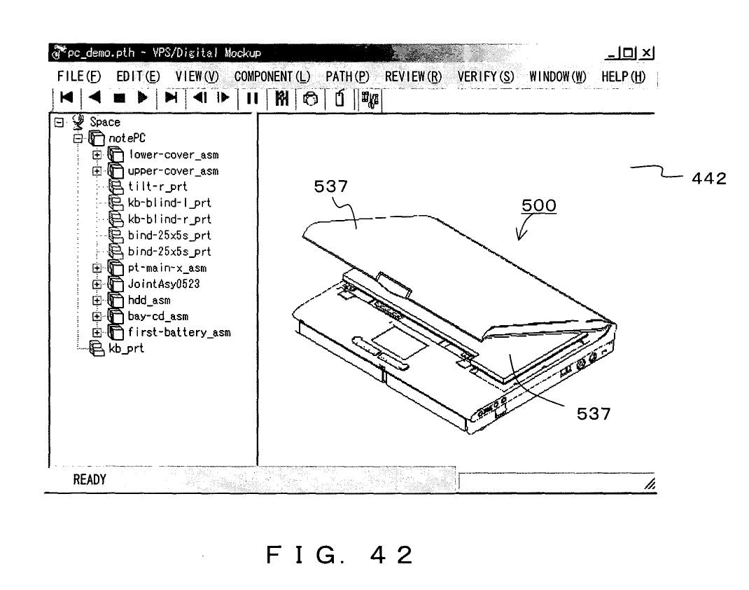

If this object operation instruction is executed, the image 441 changes to an image 442 shown in FIG. 42. In the image 442, the keyboard is moved upward, so that the keyboard 538 interferes with the cover 537. This interference is detected by the interference detecting unit 18, and an operation instruction to avoid this interference is automatically generated by the interference avoiding unit 19.

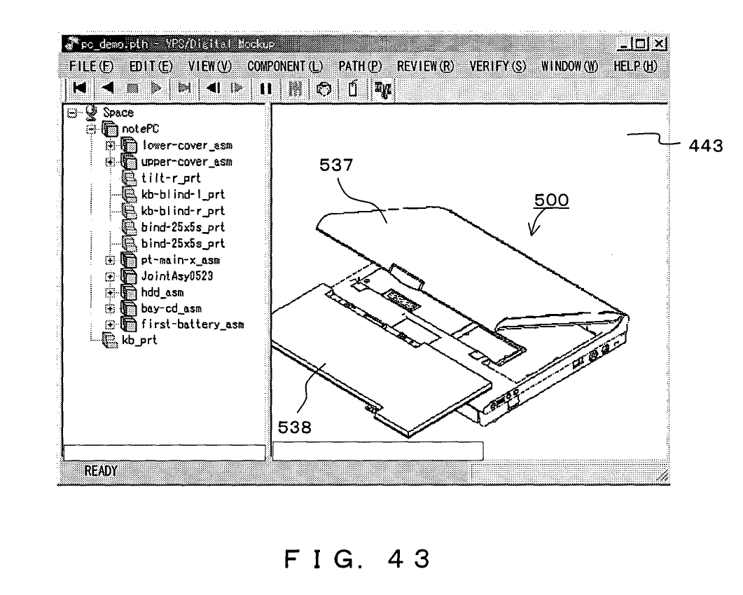

Firstly, the interference avoiding unit 19 generates/executes an object operation instruction to move the keyboard 538 in a movable direction (forward direction) by a distance (the depth of the cover 537) that can avoid the interference with the cover 537. As a result, an image 443 in which the keyboard 538 is moved so that its rear edge is moved to the position equal to the front edge of the cover 537 in the forward direction is displayed as shown in FIG. 43.

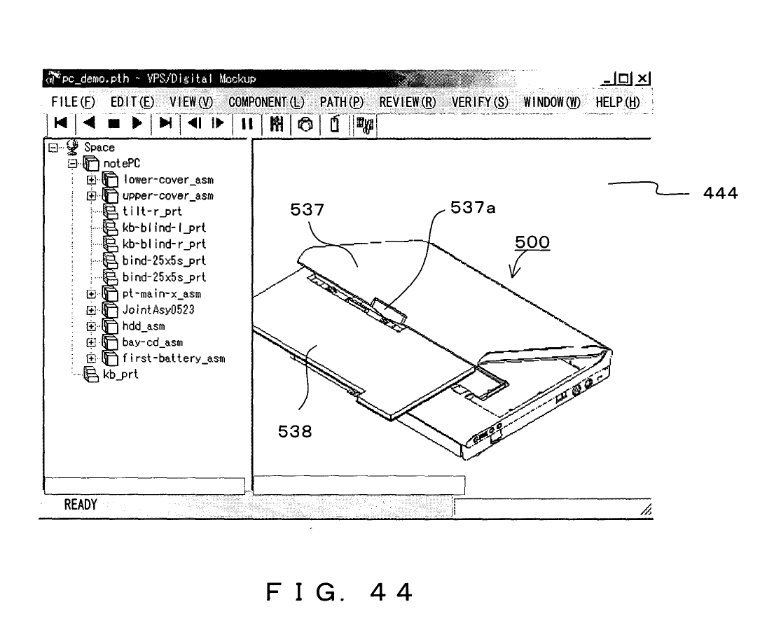

Next, the interference avoiding unit 19 generates/executes an object operation instruction to move the keyboard 538 upward for the image 443. As a result, the keyboard 538 interferes with a hook 537a of the cover 537 as represented by an image 444 shown in FIG. 44.

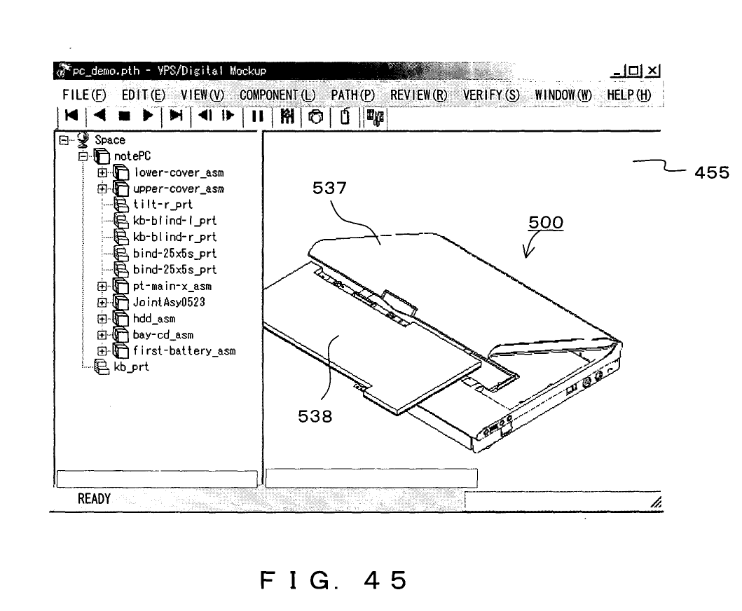

The interference avoiding unit 19 generates/executes an object operation instruction to move the keyboard 538 in its movable direction (forward direction) by a distance (the size of the hook 537a) that can avoid the interference for the image 444. As a result, an image 455 in which the keyboard 538 is moved by the size of the hook 537a in the forward direction is displayed as shown in FIG. 45.

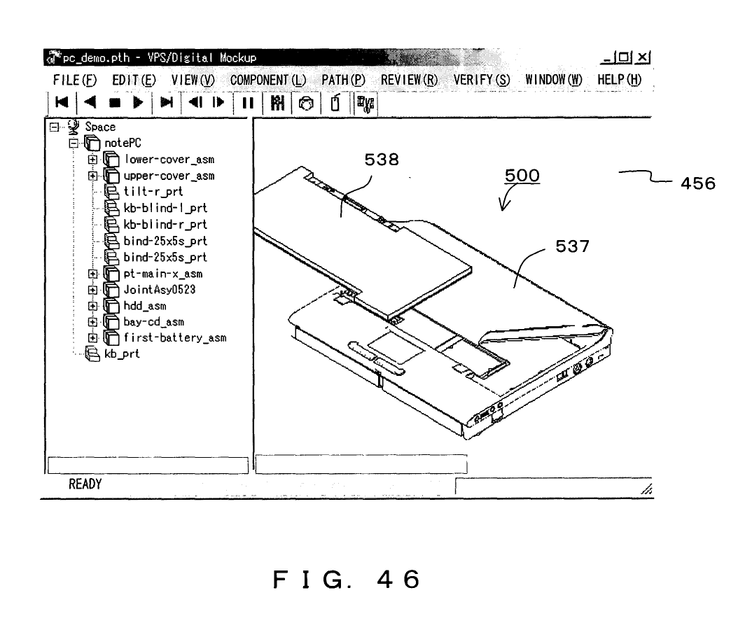

Then, the interference avoiding unit 19 generates/executes an object operation instruction to move the keyboard 538 up to the height specified by the user. As a result, an image 456 in which the keyboard 538 is moved to the height specified by the user without causing interference with the hook 537a of the cover 537 is displayed as shown in FIG. 46.

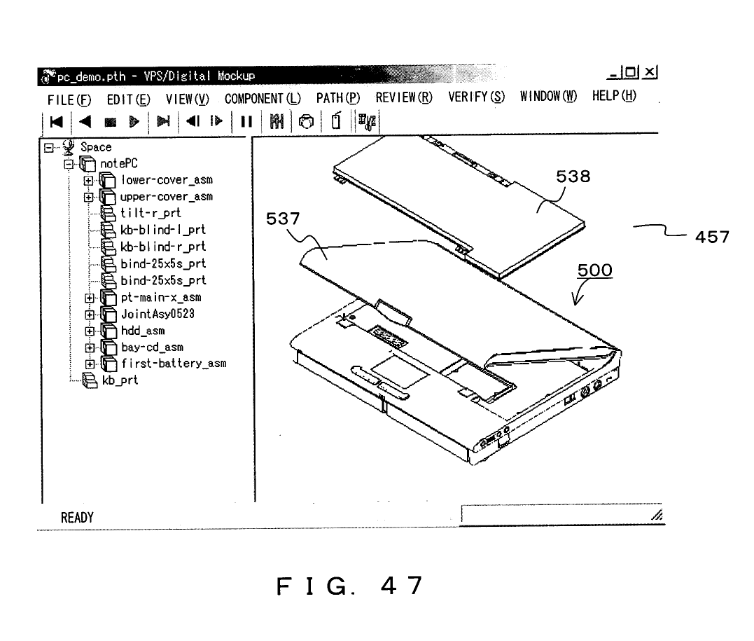

Next, the interference avoiding unit 19 generates/executes an object operation instruction to move the keyboard 538 by the distance moved in the images 443 and 455 in the reverse direction (backward direction). As a result, an image 457 in which the keyboard 538 is moved from the position in the image 441 to the position specified by the user is displayed as shown in FIG. 47.

As described above, if an object operation instruction input by a user is executed, and if interference occurs by executing a target object to be operated as specified by the instruction, the target object is moved to the position specified by the user after being operated to avoid the interference.

In the above described example where the interference is avoided, the interference avoidance is attempted up to twice. Since this interference avoidance process is a process for searching a bypass to avoid interference in a trial-and-error manner. Therefore, its processing time depends on the computation ability of a CPU of the system, etc. Accordingly, the number of trial-and-error times that interference avoidance is attempted depends on a system implementation. Therefore, in a system which implements the interference avoidance process only once, interference is determined to be unavoidable when the keyboard 538 interferes with the hook 537a, and the instruction to move the keyboard 538 becomes an error in the above described example. In this case, for instance, a dialog box that notifies the user of the input error of the move instruction is displayed. If the interference avoidance process is repeated many times until the bypass of interference avoidance is found, this is not impractical in terms of processing time and calculation cost. Therefore, if the interference avoidance process is implemented in a system, the number of trial-and-error times that interference is avoided is restricted to an appropriate number of times.

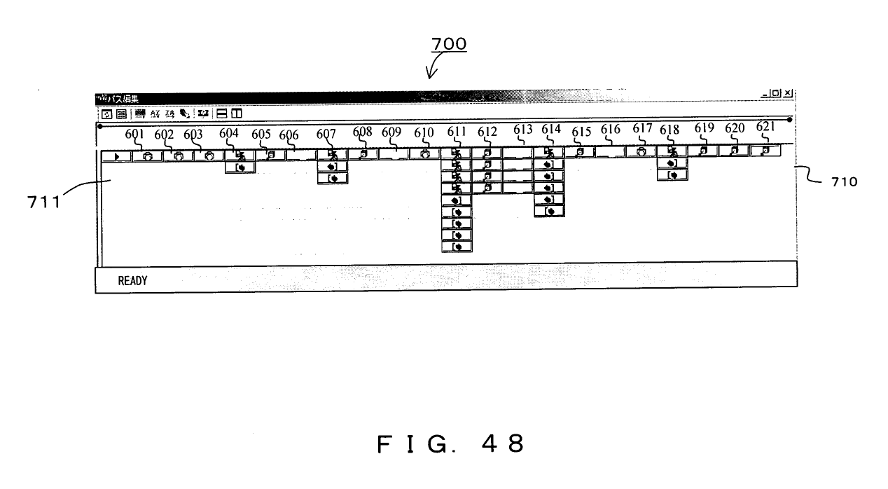

The animation editing system 10 according to this preferred embodiment can edit an operation instruction sequence 600 for displaying an animation, which is created as described above. This editing can be made via an editing screen shown in FIG. 48.

As shown in this figure, an editing screen 700 has a sheet 710 on which cells 711 are arranged two-dimensionally. Each of the cells 711 corresponds to one operation instruction, and icons of operation instructions to be executed simultaneously are displayed in cells 711 in each of columns on the sheet 710. Additionally, when an animation is replayed, execution starts sequentially from the operation instruction displayed in a cell 711 in the left column (from the left column to the right column). The editing screen 700 is an editing screen of the operation instruction sequence 600 shown in FIG. 36, and a “replay start instruction” icon is displayed in a cell 711 at the top of the leftmost column. Additionally, numerals 601 to 621 assigned to the second and subsequent columns indicate that the columns respectively correspond to the operation instructions 601 to 621 shown in FIG. 36. When this sequence is actually replayed as an animation, many images are inserted between operation instructions (between columns on the sheet 710).

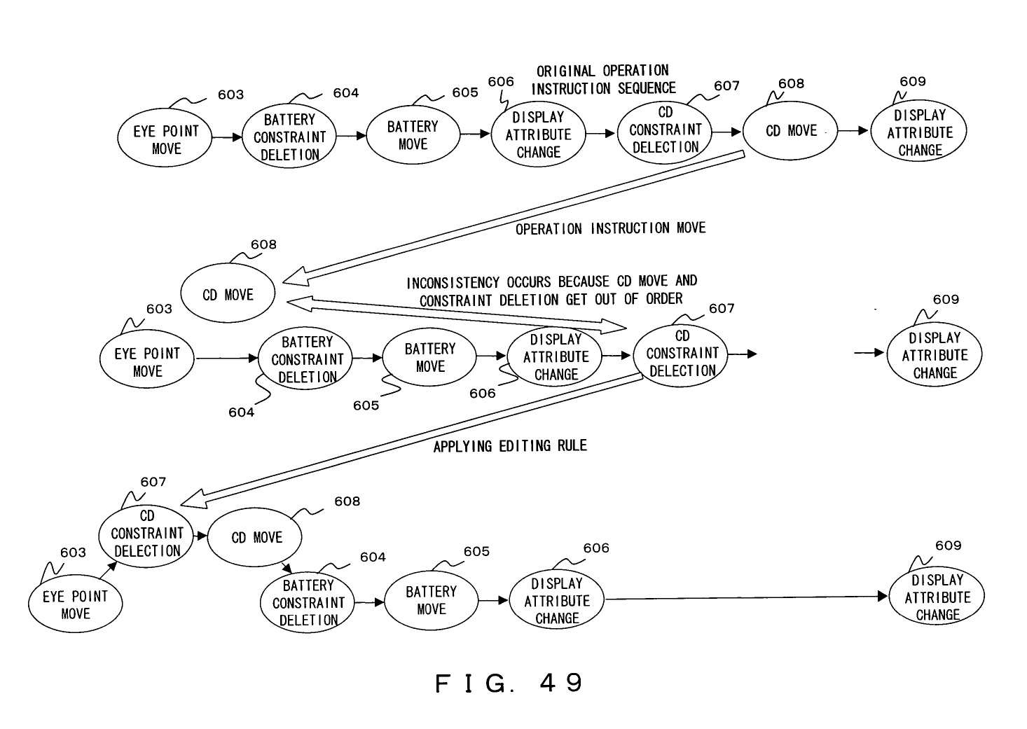

An example of editing of the operation instruction sequence 600 shown in FIG. 36 is explained next with reference to FIG. 49. This figure explains an application example of editing rules stored in the editing rule storing unit 14.

FIG. 49 shows the editing operation for moving the CD move instruction 608 before the battery constraint deletion instruction 604. If a user attempts to move the CD move instruction 608 alone before the battery constraint deletion instruction 604, this instruction 608 is executed before the CD constraint deletion instruction 607. This is inconsistent with the above described editing rule. Accordingly, the operation instruction editing unit 21 applies the editing rules, and moves the CD constraint deletion instruction 607 and the CD move instruction 608 before the battery constraint deletion instruction 604.

The operation for moving the CD move instruction 608 before the battery constraint deletion instruction 604 is performed by selecting an “operation instruction move” via the operation inputting unit 22, and by dragging the cell 711 (the cell 711 at the top of the ninth column), in which the icon of the CD move instruction 608 is displayed, above a cell 711 (the cell 711 at the top of the fifth column), in which the icon of the battery constraint deletion instruction 604 is displayed, with an operation of the mouse of the operation inputting unit 22.

A specific example of animation editing made by the animation editing system 10 according to this preferred embodiment is explained next. This specific example is an editing example of an animation which disassembles a notebook PC (removes an HDD unit from the notebook PC).

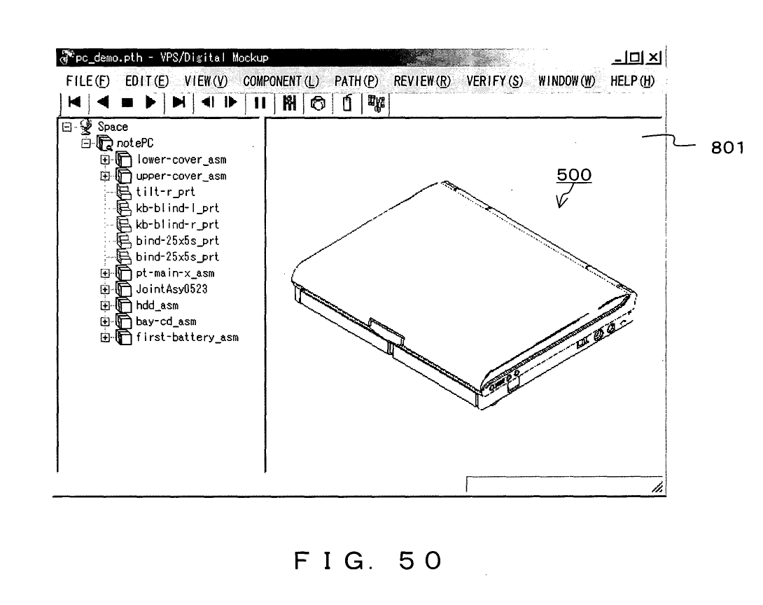

First of all, the object of the notebook PC 500 is read from the three-dimensional model storing unit 11, and an image 801, in which the entire notebook PC 500 is arranged in virtual space when viewed from the right side direction, is displayed as shown in FIG. 50.

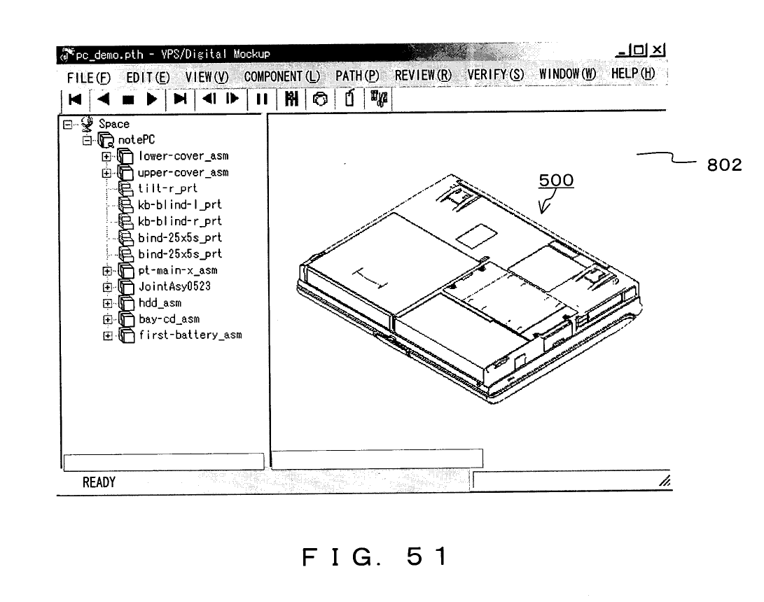

Next, an instruction to move an eye point to the back side of the notebook PC 500 is input for the image 801, so that an image 802 in which the back side of the notebook PC 500 appears is displayed as shown in FIG. 51.

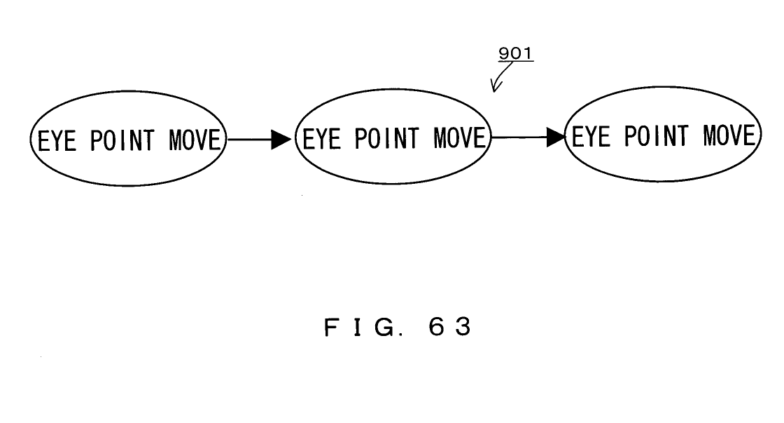

If the image which reverses the notebook PC 500 is displayed as an animation as described above, some eye point move instructions are complemented between the images 801 and 802 by the animation editing system 10. This is because the rotation distance is large. Consequently, an operation instruction sequence 901 composed of three eye point move instructions is generated by the operation instruction editing unit 21 as shown in FIG. 63.

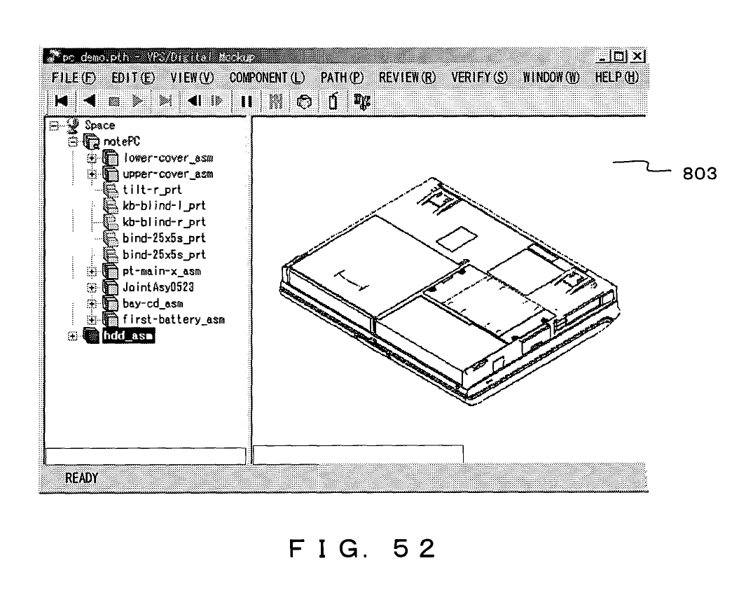

Next, a configuration change instruction (constraint deletion instruction) to delete the constraint of the HDD unit 534 is input, and the object of the HDD unit 534 is removed from the object tree of the notebook PC 500. An image 803 shown in FIG. 52 represents the notebook PC 500 that is in the state where the HDD unit 534 is released from the constraint of the notebook PC 500.

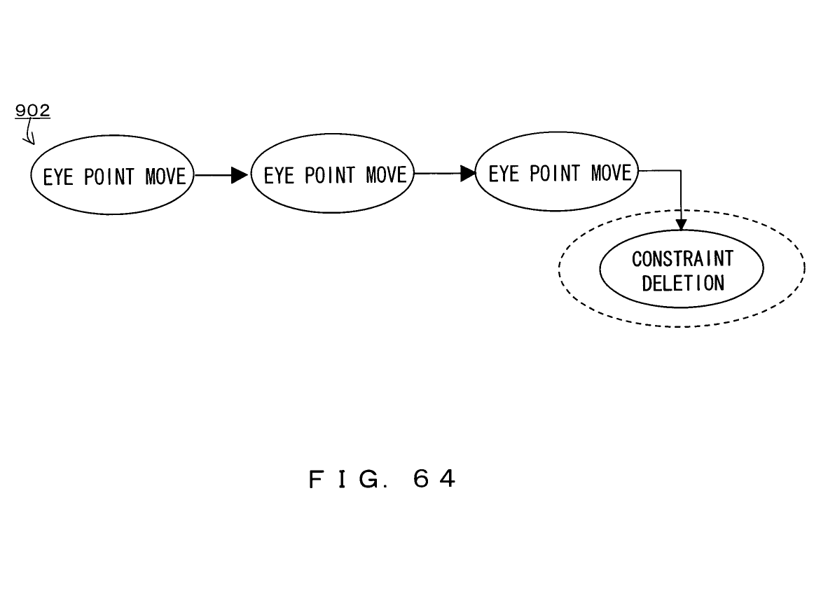

As a result, an operation instruction sequence 902 obtained by adding the constraint deletion instruction (the constraint deletion instruction for the HDD unit 534) to the above described operation instruction sequence 901 is generated by the operation instruction editing unit 21 as shown in FIG. 64.

Then, if an object move instruction to move the HDD unit 534 is input for the image 803, interference is detected by the interference detecting unit 18. This is because the cover (HDD cover) 532 of the HDD unit 534 is closed in this case. Accordingly, the interference avoiding unit 19 attempts to avoid the interference. However, since an avoidance path is not found, the object move instruction becomes an error.

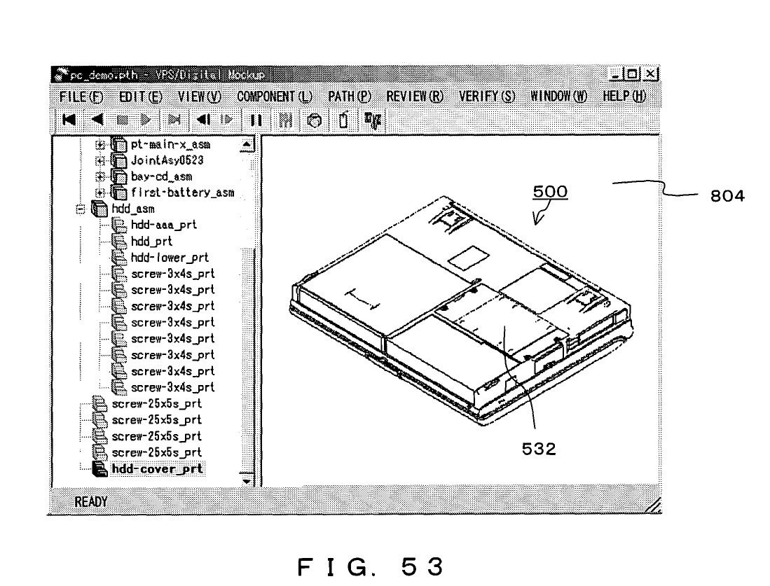

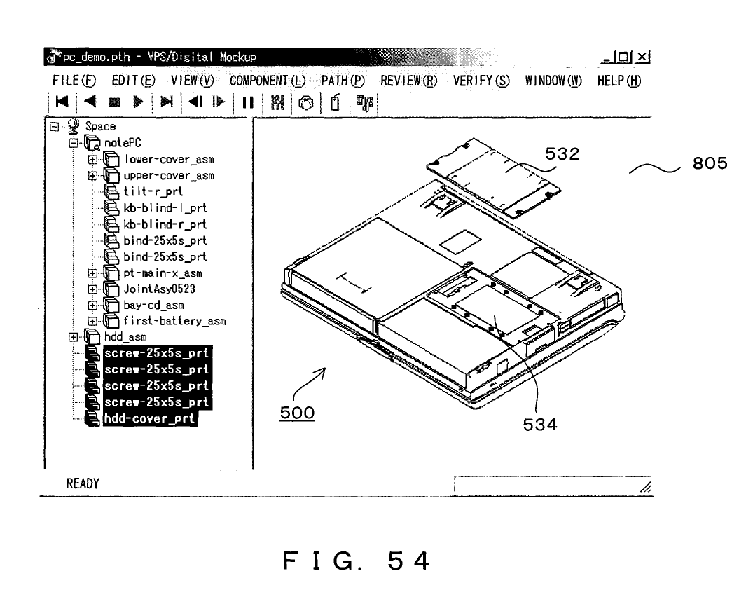

Therefore, constraint deletion, move, and nondisplay instructions are input for the screws 531 (not shown) and the HDD cover 532. As a result, images 804, 805, and 806, which are shown in FIGS. 53, 54, and 55, are sequentially displayed. The image 805 represents the state where the HDD cover 532 is moved, whereas the image 806 represents the state where the moved HDD cover 532 is nondisplayed.

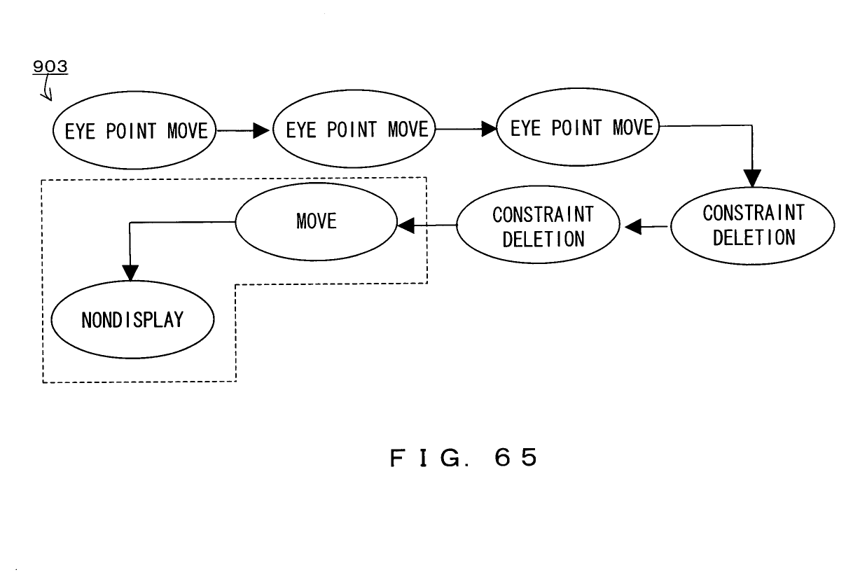

Consequently, the operation instruction editing unit 21 generates an operation instruction sequence 903 obtained by adding the constraint deletion instruction (for the screws 531 and the HDD cover 532), the move instruction (for the screws 531 and the HDD cover 532), and the nondisplay instruction (for the screws 531 and the HDD cover 532) to the above described operation instruction sequence 902 as shown in FIG. 65.

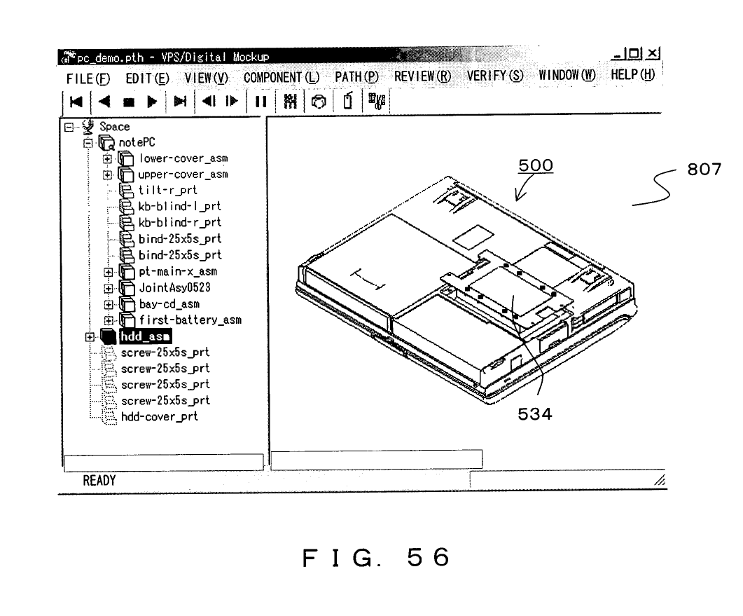

Next, if an instruction to move the HDD unit 534 in the left direction is input for the image 806, the interference detecting unit 18 detects that the HDD unit 534 interferes with the accommodating unit of the HDD unit 534 of the notebook PC 500 when the HDD unit 534 is moved in the left direction. Since the HDD unit 534 can be moved upward in this case, the interference avoiding unit 19 generates a move instruction to move the HDD unit 534 upward. Then, this move instruction is executed, so that an image 807 in which the HDD unit 534 is moved upward is displayed as shown in FIG. 56.

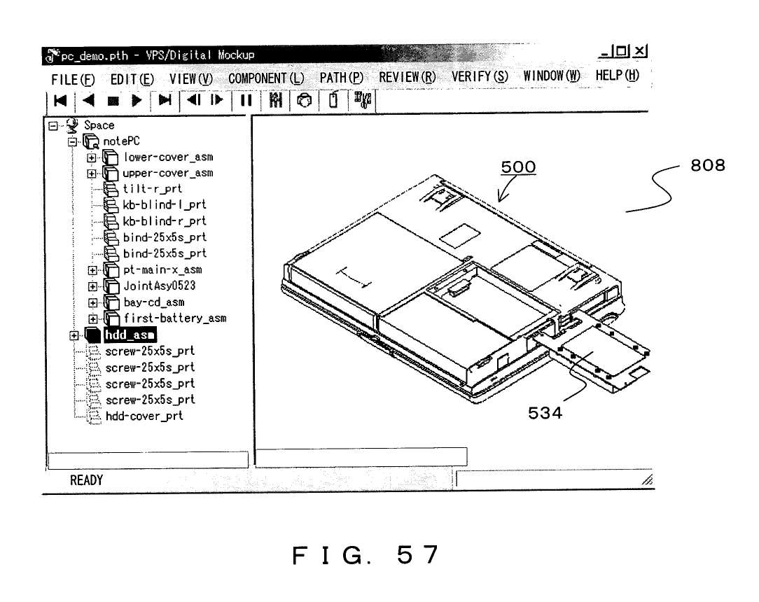

Next, the interference avoiding unit 19 generates a move instruction to move the HDD unit 534 in the left direction by the distance specified by the user. This move instruction is executed, so that an image 808 in which the HDD unit 534 is moved in the left direction is displayed as shown in FIG. 57.

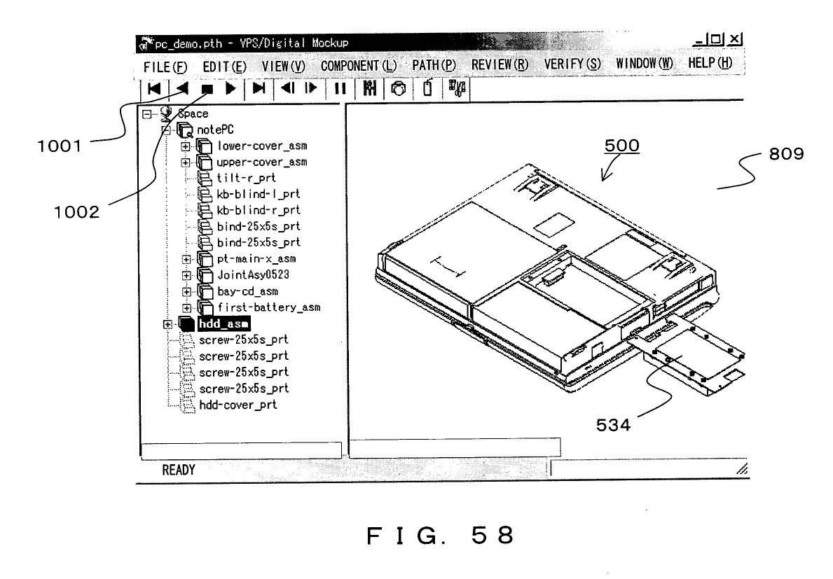

Then, the interference avoiding unit 19 generates a move instruction to move the HDD unit 534 downward by the distance moved upward so as to avoid the interference. This move instruction is executed, so that an image 809 in which the HDD unit 534 is moved to the position specified by the user is displayed as shown in FIG. 58.

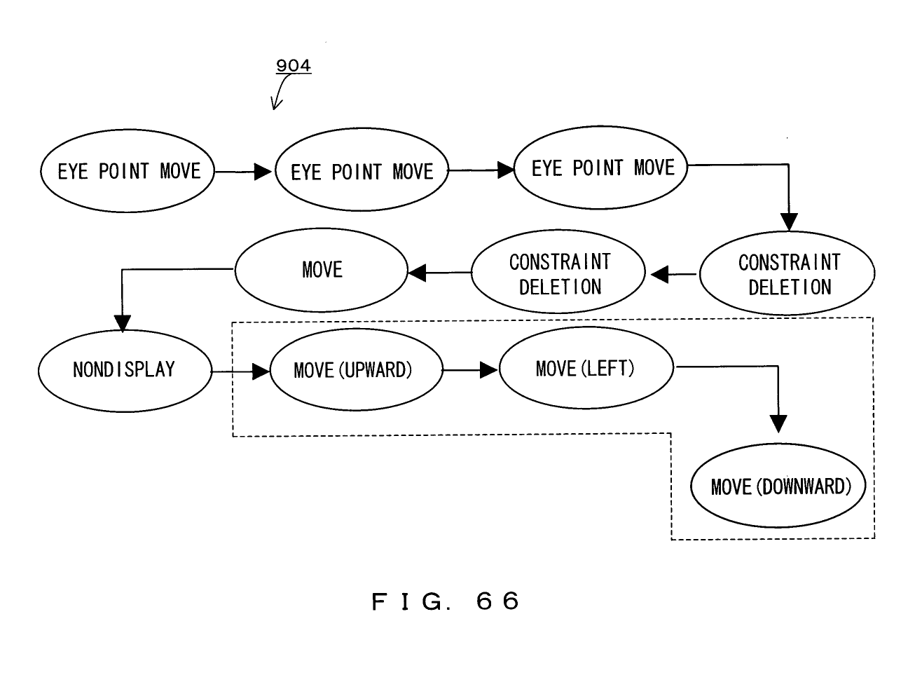

As a result of the above described operations, the HDD unit 534 can be successfully moved to the position specified by the move instruction input by the user in the virtual space. Therefore, the operation instruction editing unit 21 generates an operation instruction sequence 904 obtained by adding the move instruction (for the HDD unit 534 upward), the move instruction (for the HDD unit 534 in the left direction), and the move instruction (for the HDD unit 534 downward), which are generated by the interference avoiding unit 19, to the operation instruction sequence 903 shown in FIG. 65, as shown in FIG. 66.

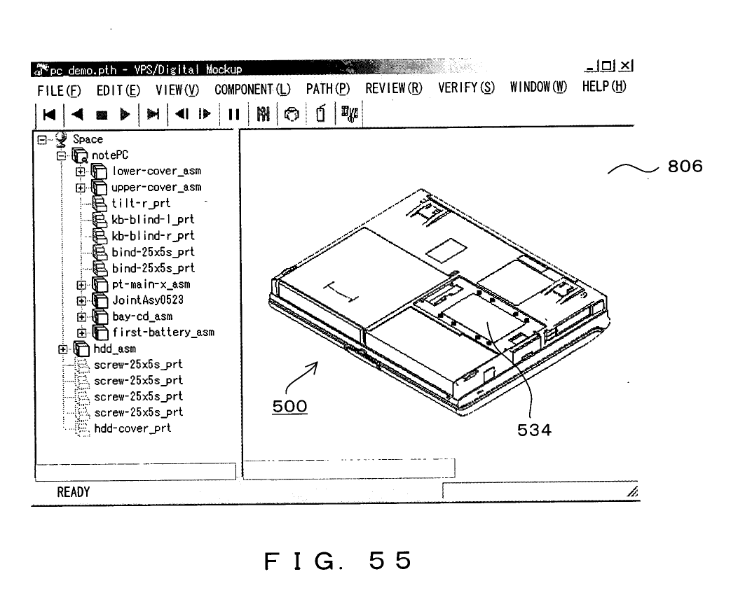

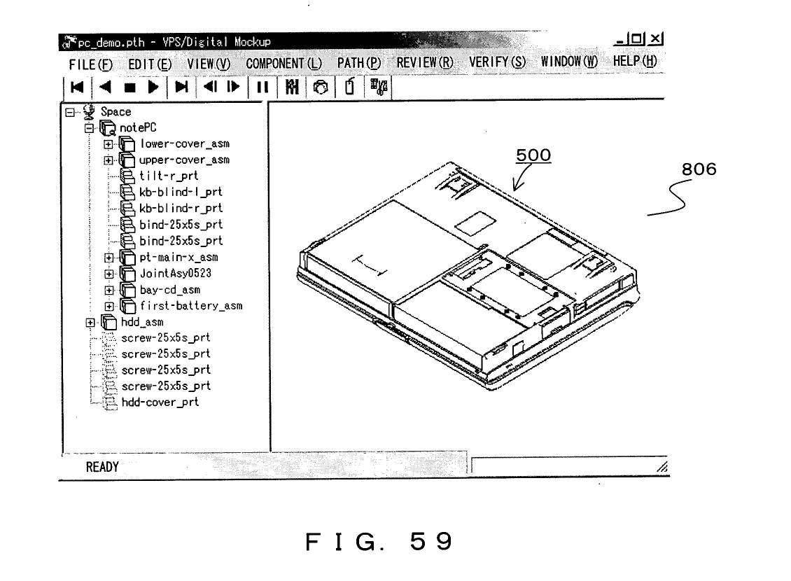

Here, turning back to the image 806 (see FIG. 55) of the scene before the HDD unit 534 is moved as shown in FIG. 59. This image 806 can be displayed by clicking a rewind button 1001 and a stop button 1002, which are arranged in an upper portion of a display screen, with the mouse of the operation inputting unit 22 when the image 809 shown in FIG. 58 is displayed. Namely, the rewind button 1001 may be clicked first, and the stop button 1002 may be clicked after the image 806 is displayed.

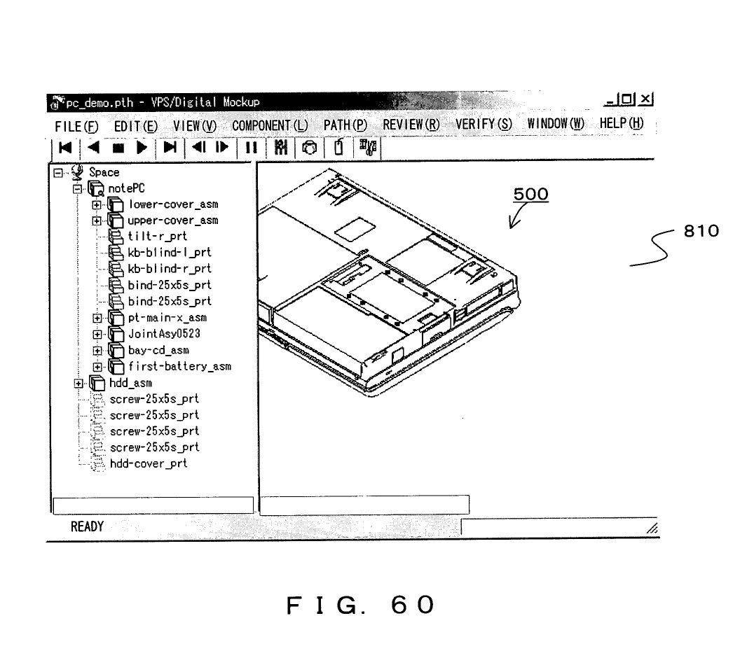

An eye point move instruction is input in the state where the image 806 is redisplayed, so that an image 810 in which the entire notebook PC 500 is moved in the upper left direction of the virtual space is displayed as shown in FIG. 60.

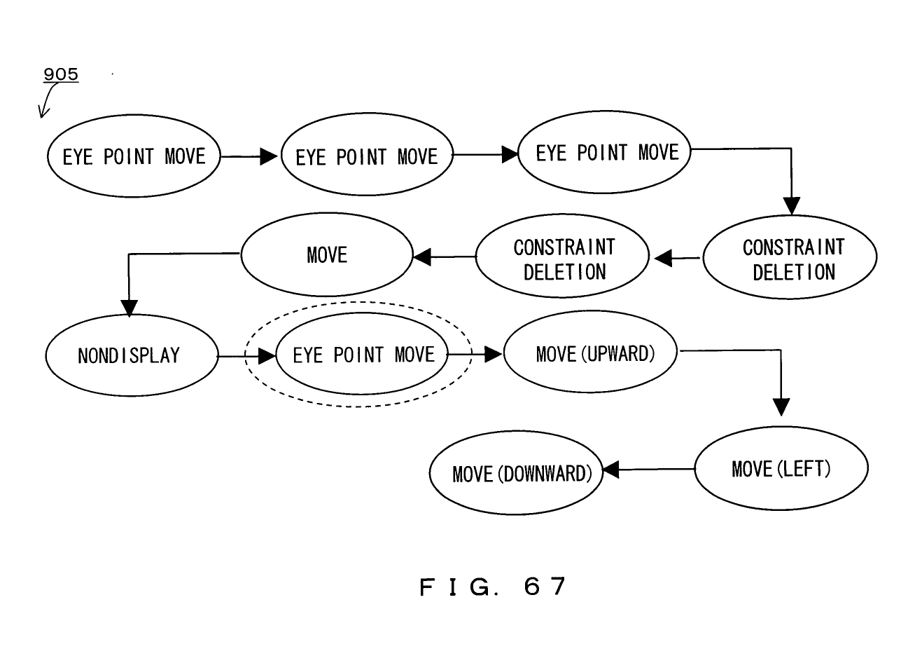

Consequently, as shown in FIG. 67, the operation instruction editing unit 21 generates an operation instruction sequence 905 obtained by inserting the eye point move instruction between the nondisplay instruction and the move instruction (upward) of the operation instruction sequence 904 shown in FIG. 66.

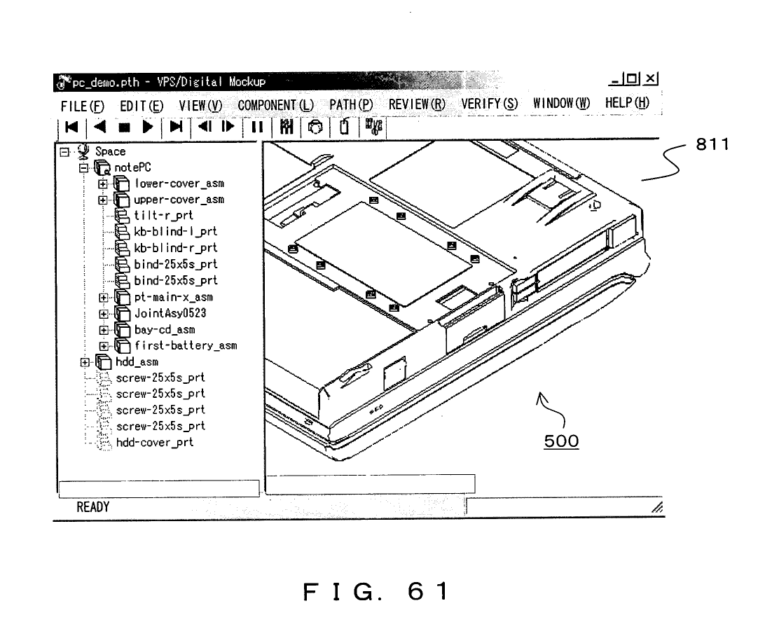

A zoom-in instruction is input for the image 810 shown in FIG. 60, so that an image 811 in which the right side of the notebook PC 500 is enlarged and displayed is displayed as shown in FIG. 61.

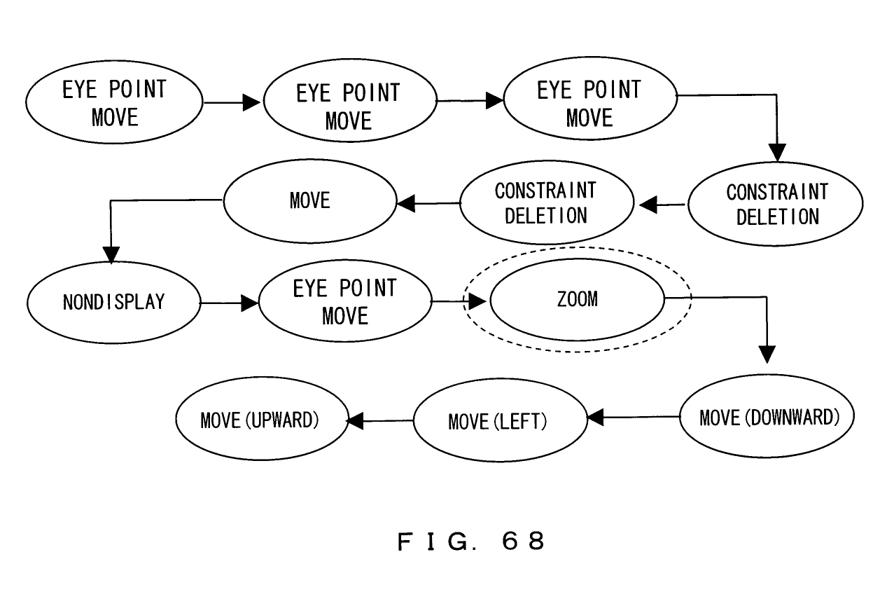

As a result, the operation instruction editing unit 21 generates an operation instruction sequence 906 obtained by inserting the zoom (zoom-in) instruction between the eye point move instruction and the move instruction (upward) of the operation instruction sequence 905 shown in FIG. 67, as shown in FIG. 68.

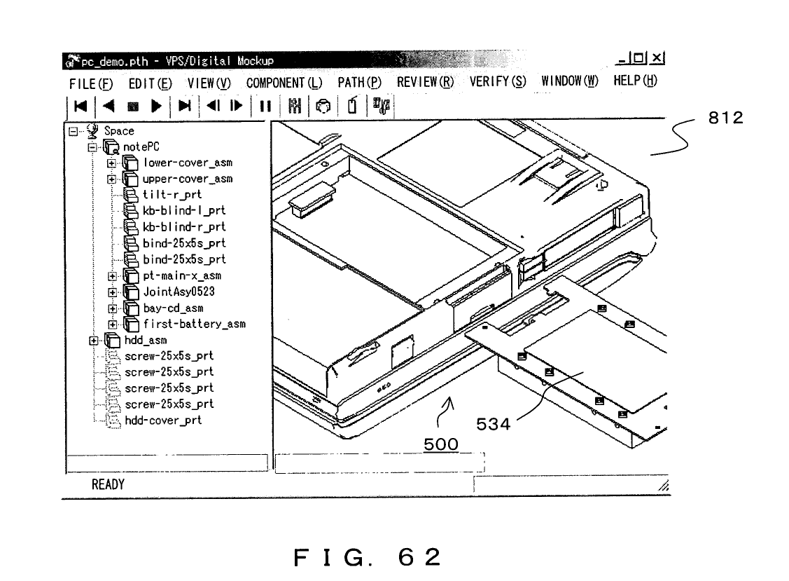

Then, the user makes an image 813 (812?) shown in FIG. 62 displayed, and finally verifies that the HDD unit 534 is moved to the desired position.

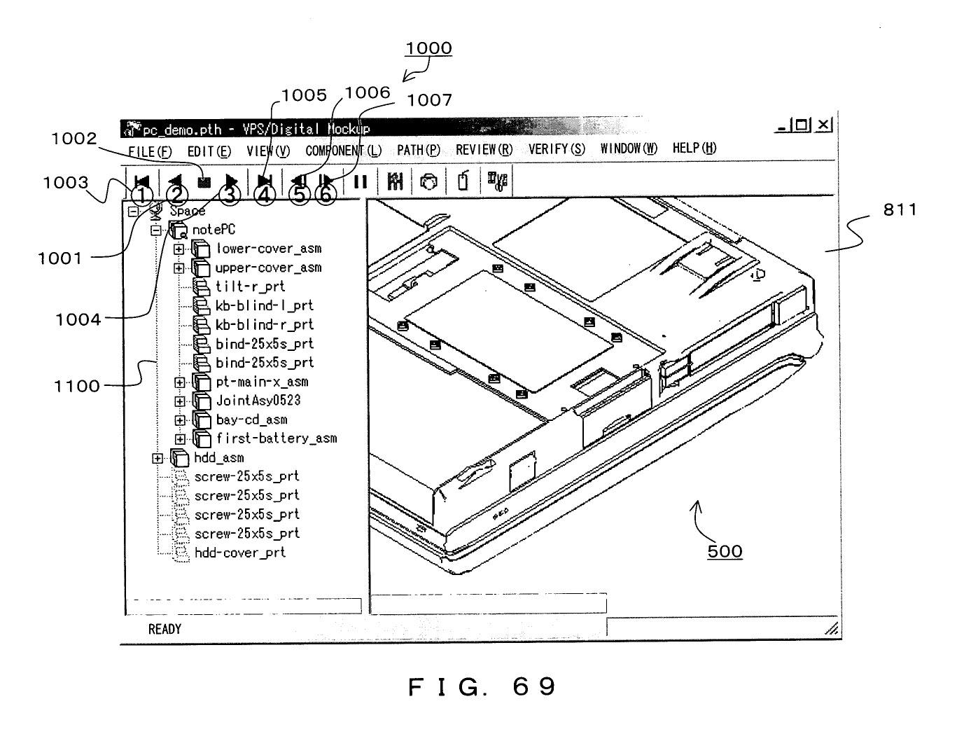

Here, an operation method for displaying the image 812 from the image 811 is explained with reference to FIG. 69.

FIG. 69 shows a screen on which the image 811 is displayed.

On a screen 1000 shown in this figure, buttons 1001 to 1007 for controlling an animation replay are arranged in the upper left portion of the image 811. Capabilities of the respective buttons are as follows.

1001—Rewinding to the first instruction of an operation instruction sequence.

1002—Replaying the operation instructions of an operation instruction sequence in reverse order.

1003—Replaying the operation instructions of an operation instruction sequence in order.

1004—Stopping replay.

1005—Fast-forwarding to the end of the last instruction of an operation instruction sequence.

1006—Rewinding the operation instructions of an operation instruction sequence by one instruction in reverse direction.

1007—Fast-forwarding the operation instructions of an operation instruction sequence by one instruction in forward direction.

To display the image 812 from the state where the image 811 is displayed, for example, the button 1003 is clicked with the mouse. As a result, the move instruction (upward), the move instruction (left), and the move instruction (downward) of the operation instruction sequence 906 are sequentially executed, and the image 812 is finally displayed.

With the animation editing system 10 according to this preferred embodiment, a tree 1100 which represents the hierarchical object structure of the notebook PC 500 is displayed, for example, on the left side of the screen as shown in FIG. 69. In the tree 1100 shown in this figure, Space represents virtual space, and the object (notePC) of the notebook PC 500, and an object (hdd_asm) of a set of objects for the HDD are linked below Space, and objects in lower hierarchies (lower_cover_asm, pt-main-x_asm, etc.) are further linked to the above described objects.

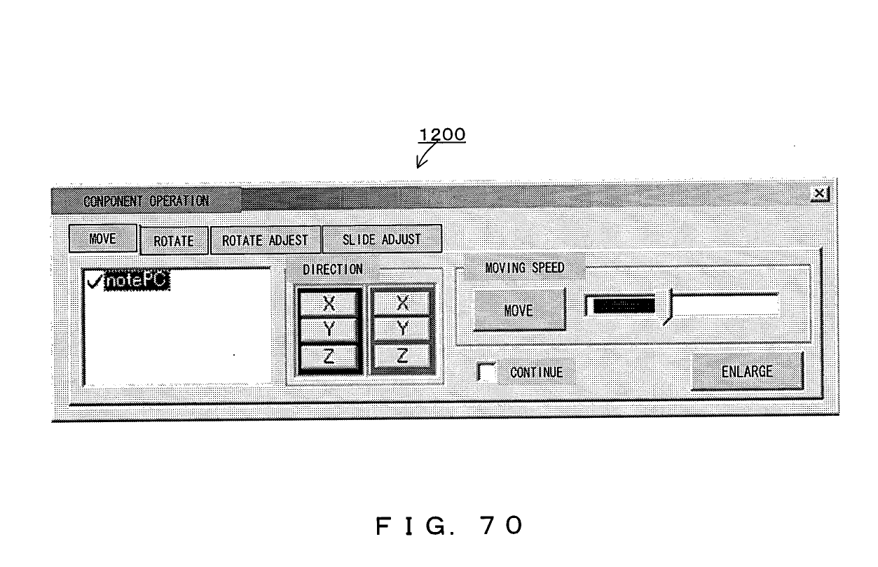

An object to be operated can be selected from the above described tree 1100, or an image (the image 811, etc.) displayed on its right side. If an object is operated with an image, it can be directly operated with an operation such as a click, a drag, etc. of the mouse of the operation inputting unit 22. In the meantime, if an object is operated with the tree 1100, a dialog box 1200 shown in FIG. 70 is opened, and the object is indirectly operated via the dialog box 1200.

As a title bar of the dialog box 1200 shown in this figure, “component operation” is displayed, and buttons such as “move”, “rotate”, “rotation adjust”, and “slide adjust” are arranged below the title bar. Additionally, buttons for specifying X, Y, and Z directions, a box for setting the moving speed of an object move or an eye point move, and the like are arranged.

As described above, the animation editing system 10 according to this preferred embodiment comprises the following capabilities.

(1) An animation can be created by holding an object (a person or a physical object that appears in an animation), which configures an animation, not as an image but as a three-dimensional model, and by using a move instruction for an eye point or an object in virtual space, or a series of operation instructions composed of eye point and object move instructions.

(2) An animation can be edited by editing an operation instruction for an eye point or an object.

(3) An editing operation for creating an animation, which is inconsistent with the real world, can be prevented/avoided by holding editing rules, and by strictly observing the editing rules.

(4) An animation unsuitable for the real world can be prevented from being created/edited by holding a constraint condition of an object which configures the animation, and by checking whether or not the constraint condition is satisfied.

(5) A capability for checking the interference between objects when an object is moved in virtual space is comprised. Additionally, a capability for moving an object so as to avoid interference if the interference occurs is comprised.

(6) Discontinuity is resolved by complementing an instruction to move an eye point or an object from a position of a scene immediately before the discontinuity to the position of a scene immediately after the discontinuity, if the discontinuity occurs between an inserted/deleted/moved scene and a scene before or after that scene when an animation is edited.

(7) A plurality of operation instruction sequences are stored in the operation instruction storing unit 12, and one operation instruction sequence can be selected from among the plurality of operation instruction sequences when an animation is edited/replayed.

As described above, according to the present invention, the following effects can be obtained.

(1) A constraint check or an interference check is made for an object to be operated when an animation is created/edited. Therefore, an animation appropriate to the real world can be efficiently created.

(2) A user applies editing rules created in advance when editing an animation, whereby the animation on which the real world is properly reflected can be edited while maintaining its appropriateness.

(3) Discontinuous scenes are automatically complemented, so that an animation whose scenes do not jump, and is easy to understand can be efficiently created.

The above described effects of (1) to (3) are especially advantageous when an animation which instructs operations of various types such as assembly/disassembly of a product, etc. is created.

(4) An animation is created as an instruction sequence of an object operation instruction and an eye point operation instruction. Therefore, a plurality of operation instruction sequences are only generated and held even if a plurality of animations are created. As a result, the amount of data for holding the animations can be significantly reduced in comparison with a conventional method.

(5) When an animation is replayed, it is created while moving an object represented by a three-dimensional model with an object operation instruction and an eye point operation instruction in virtual space. Consequently, a slow-/high-speed replay can be made smoothly.

What is claimed is:

1. An animation creating/editing apparatus, comprising:
a three-dimensional model storing unit storing an object configuring an image of an animation as three-dimensional model information; and
an operation instruction editing unit creating/editing an animation by generating/editing an operation instruction sequence configured by an object operation instruction and an eye point operation instruction, which are operation instructions for the object.

2. The animation creating/editing apparatus according to claim 1, further comprising:
an interference detecting unit detecting an occurrence of interference between objects, which is caused by executing the object operation instruction; and
an interference avoiding unit generating an object operation instruction to avoid the interference, if the occurrence of the interference is detected by said interference detecting unit.

3. The animation creating/editing apparatus according to claim 1, further comprising:
a discontinuity detecting unit detecting an occurrence of discontinuous scenes, which is caused by executing the eye point operation instruction or the object operation instruction; and
a complementary instruction generating unit generating an object operation instruction or an eye point operation instruction to generate a scene which complements between the discontinuous scenes, if the occurrence of the discontinuous scenes is detected by said discontinuity detecting unit.

4. The animation creating/editing apparatus according to claim 1, wherein:
the three-dimensional model information holds a constraint condition between objects; and
a constraint detecting unit detecting an object operation instruction which violates the constraint condition as an error is further comprised.

5. The animation creating/editing apparatus according to claim 1, further comprising:
an editing rule storing unit storing editing rules to be observed when an object operation instruction is inserted/deleted/moved in/from/within the operation instruction sequence, when an animation is edited; and
an operation instruction editing unit referencing the editing rules, and preventing/avoiding an operation if the operation for inserting/deleting/moving an object operation instruction which violates the editing rules in/from/within the operation instruction sequence is performed.

6. A program for causing a computer to execute a process, the process comprising:
storing an object configuring an image of an animation as three-dimensional model information in a first storing unit; and
creating/editing an animation by generating/editing an operation instruction sequence configured by an object operation instruction and an eye point operation instruction, which are operation instructions for the object.

7. The program according to claim 6, the process further comprising:
detecting an occurrence of interference between objects, which is caused by executing the object operation instruction; and
generating an object operation instruction to avoid the interference, if the occurrence of the interference is detected.

8. The program according to claim 6, the process further comprising:
detecting an occurrence of discontinuous scenes, which is caused by executing the eye point operation instruction or the object operation instruction; and
generating an object operation instruction or an eye point operation instruction to generate a scene which complements between the discontinuous scenes, if the occurrence of the discontinuous scenes is detected.

9. The program according to claim 6, the process further comprising:
holding a constraint condition between objects in the three-dimentional model inofmration; and
detecting an object operation instruction which violates the constraint condition as an error.

10. The program according to claim 6, the process further comprising:
storing, in a second storing unit, editing rules to be observed when an object operation instruction is inserted/deleted/moved in/from/within the operation instruction sequence, when an animation is edited; and
referencing the editing rules, and preventing/avoiding an operation if the operation for inserting/deleting/moving an object operation instruction which violates the editing rules in/from/within the operation instruction sequence is performed.
